(19) United States
(12) Patent Application Publication
(10) Pub. No.: US 2019/0162287 A1
(43) Pub. Date: May 30, 2019

(54) ROTATION TRANSMISSION MECHANISM, BICYCLE PROVIDED WITH ROTATION TRANSMISSION MECHANISM, AND ELASTICALLY-DEFORMABLE BODY USED IN ROTATION TRANSMISSION MECHANISM

(71) Applicants: Yoichiro Hamamoto, Miyazaki-shi (JP); Godo Kaisha IP Bridge 1, Tokyo (JP)

(72) Inventor: Yoichiro Hamamoto, Miyazaki-shi (JP)

(21) Appl. No.: 15/824,057

(22) Filed: Nov. 28, 2017

(51) Int. Cl. F16H 55/14; F16H 55/30; B62M 9/00

(52) U.S. Cl. CPC F16H 55/14; F16H 2055/306; B62M 9/00; F16H 55/30

(57) ABSTRACT

The present invention provides a rotation transmission mechanism including an internal rotation member and an external rotation member rotatably arranged with respect to the internal rotation member. The internal rotation member has one or a plurality of outer-peripheral-projected portions protruding toward an outer-peripheral side. The external rotation member has one or a plurality of inner-peripheral-projected portions. The outer-peripheral-projected portions have a forward-movement surface located at a position displaced from a center of the outer-peripheral-projected portion in a forward movement direction in which the rotation transmission mechanism rotates by forward movement. An elastically-deformable portion is disposed between the forward-movement surface and the inner-peripheral-projected portion. A space is partially formed in the elastically-deformable portion. When the internal rotation member rotates relative to the external rotation member, the elastically-deformable portion is sandwiched between the outer-peripheral-projected portion and the inner-peripheral-projected portion and is thereby elastically deformed.

### BACKGROUND OF THE INVENTION

### Field of the Invention

The present invention relates to a rotation transmission mechanism and an elastically-deformable body used in the rotation transmission mechanism and particularly relates a rotation transmission mechanism to be attached to and used in a rotation shaft such as a crankshaft of a bicycle.

### Description of Related Art

In the case where a rider rotates a wheel of a bicycle by a human power, once the bicycle starts moving, it is possible to move with a small force. However, when starting of a bicycle by pedaling, for example, starting of riding, accelerating of riding, moving on slopes, or the like, riders receive a particularly large repulsion force from the bicycle, part of input energy returns as an impact to their knees, ankles, lumbar, or the like, not only a large load is generated in the human body but also input energy cannot be effectively used, and a propulsive force has been reduced. Furthermore, in the case of suddenly starting or suddenly accelerating the bicycle, in the case of moving on steep slopes, or in the case where a body weight of the rider of the bicycle or a weight of a load mounted on the bicycle is heavy, or the like, the load (resistance force) to the human body particularly becomes larger, and the necessary energy needed increases accordingly.

Transmission of power in a bicycle is carried out by converting an upward and downward motion of feet into rotary motion by crank. Because of this, particularly, it is difficult to smoothly transmit leg's power to the bicycle at the top dead center and the bottom dead center, the load applied to knees or ankles increases, torque stops, and a reduction in speed occurs. Furthermore, in the case where a bicycle moves at low speeds, the bicycle is likely to wobble right and left with respect to the traveling direction thereof, and there is a problem in that the stability in riding is degraded.

Therefore, conventionally, for the purpose of absorbing impact when a bicycle moves, achieving improvement of rotation efficiency thereof, smoothing a propulsive force and acceleration and thereby reducing the rider's fatigue, or the like, various configurations have been studied.

For example, Japanese Unexamined Patent Application, First Publication No. 2003-312581 (hereinbelow, referred to as Patent Document 1) discloses “a bicycle provided with an automatic elastic change type crank mechanism in which a radius of rotation of a pedal becomes small in a cruise riding mode, the radius of rotation of the pedal automatically extends depending on a resistance force in a riding mode in which a heavy weight is loaded, and thereby a large rotational moment can be obtained”.

Japanese Unexamined Patent Application, First Publication No. H11-278350 (hereinbelow, referred to as Patent Document 2) discloses “an attenuator for a bicycle, including: a first member that is fixable to a first flame member and includes a storage space formed inside and at least one first protruding portion protruding inwardly from an inner peripheral face of the storage space; a second member that is fixable to a second flame member, is relatively and rotatably disposed in the storage space of the first member, and includes a second protruding portion protruding outwardly from an outer peripheral face; and a first elastic member that is mounted in one of two spaces formed and partitioned by both protruding portions between the first member and the second member, held by the first protruding portion and the second protruding portion, disposed so as to be spaced at a distance with respect to at least one of the inner peripheral face and the outer peripheral face, and expands and contracts due to relative rotation of both members”.

Japanese Unexamined Patent Application, First Publication No. S64-63489 (hereinbelow, referred to as Patent Document 3) discloses “a drive gear for a bicycle, characterized in that, the drive gear includes a gear body having a plurality of teeth provided around the outer periphery thereof and a support supporting the gear body, a power transmitter transmits power from one of the gear body and the support to the other is provided between the gear body and the support, a space that allows the gear body and the support to rotate relative to each other at a predetermined angle is provided in the power transmitter, an elastic body is provided at the portion different from that of the power transmitter, the elastic body maintains a gap, is elastically deformed when the gear body and the support rotate relative to each other, absorbs the gap, and can transmits power from the power transmitter”.

Japanese Unexamined Patent Application, First Publication No. H9-076980 (hereinbelow, referred to as Patent Document 4) discloses “a power transmission device for a bicycle, characterized in that, a configuration is adopted in which a spiral spring wound in a direction opposite to a rotation direction of a front gear is incorporated in an inside-circumferential wall of the front gear, torque due to excessive stepping pressure of a pedal arm by the action of the spiral spring is accumulated in the spiral spring, when pedal input is insufficient, the accumulated torque complements the input, and rotation efficiency due to pedaling is improved”.

Japanese Unexamined Patent Application, First Publication No. S58-036789 (hereinbelow, referred to as Patent Document 5) discloses “a crank device for a bicycle, characterized in that, a clasp to which a plurality of spring receivers are provided to radially protrude outward is fitted to a gear shaft of a bicycle, a ring member that has an inner peripheral face supported by an outer circumferential edge of the spring receiver and rotates concentrically with respect to the gear shaft is fitted thereto and serves as a base portion of a crank, a spring pressing portion is provided to protrude from the inner peripheral face of the ring member so as to correspond to the spring receiver, a spring is disposed to as to be inserted between the spring receiver and the spring pressing portion, therefore, when the crank rotates by receiving a force, the ring member of the base portion also rotates in advance of the gear shaft, the protruding spring pressing portion compresses the spring, the reactive force presses the spring receiver, and the gear shaft thereby rotates”.

However, the aforementioned conventional techniques have the following problems.

(1) In the bicycle disclosed by Patent Document 1, since the radius of rotation of the pedal automatically extends so as to correspond to a resistance force, the structure of the crank mechanism becomes complicated, the number of parts increases, and there is a problem in that operational stability, workability of assembly work, and mass productivity are lacking.

Furthermore, a large output can be obtained by a small input by extending the radius of rotation of the pedal when a resistance force is larger, and it is possible to reduce a load when starting of pedaling or the like; however, the trajectory of pedaling cannot draw a circular orbit, labored pedaling is necessary, and therefore there is a problem in that a large load is applied to knees, ankles, or the like.

(2) In the attenuator for a bicycle, disclosed by Patent Document 2, when impact is applied to the first flame member or the second flame member from a road surface, the first member and the second member rotate relative to each other, the first elastic member attached to one of the spaces partitioned by both protruding portions is sandwiched between both protruding portions and is compressively deformed, an elastic restoring force occurs, and the impact is absorbed. However, since a suspension assembly is fixed to a main flame member by an outer member, impact energy is absorbed and accumulated when initial motion of the crank occurs, it is not possible to effectively utilize the accumulated energy as a propulsive force due to conversion of the energy into the torque when the elastic body restores, and improvement in rotation efficiency or acceleration, uniform rotation torque, or the like have not been considered.
(3) The drive gear for a bicycle, disclosed by Patent Document 3, has an object to reduce impact due to a driving power when pedaling begins, is configured so that an elastic body is provided between a gear body and a support and at a portion different from the power transmitter, and causes the elastic body to be torsionally deformed. Accordingly, since the elastic body is less likely to be deformed and is less likely to accumulate energy, it is difficult to effectively convert the restoring of the elastic body to be torque, and there is a problem in that effective utilization of energy lacks.

Furthermore, there are problems in that the number of parts is large, the structure is complicated, mass productivity lacks, it is difficult to replace the gear body or the elastic body since the gear body and the support are integrated into one body via the elastic body, and ease of maintenance lacks.

(4) In the power transmission device for a bicycle, disclosed by Patent Document 4, has an object to improve rotation efficiency due to pedaling by accumulating torque due to excessive stepping pressure, by causing the accumulated torque to complement input when pedal input is insufficient, and by stabilizing the input of the stepping pressure, and to relieve fatigue by making movement and acceleration smooth. However, since accumulation and complement of the torque is carried out by a spiral spring such as a spring formed in a power spring (plate spring) shape or a coil spring, an amount of time is required to accumulate torque until winding of the spiral spring is completed, a pedal shaft spins free relative to the front gear during the winding, power cannot be transmitted thereto, and there is a problem in that usability significantly is lacking.

Moreover, in the case where the spiral spring is broken, power cannot be transmitted from the pedal shaft to the front gear, movement becomes impossible, and therefore there is a problem in that reliability of power transmission and stability is lacking.

(5) In the crank device for a bicycle, disclosed by Patent Document 5, since the inner peripheral face of the ring member which serves as the base portion of the crank is supported by the outer circumferential edge of the spring receiver, the crank and the gear shaft are likely to rotate together by a frictional force between the inner peripheral face of the ring member and the outer circumferential edge of the ring member, and it is difficult to rotate the ring member in advance of the gear shaft. In addition, there are problems in that it is impossible to reliably compress the spring, the operational stability is lacking, accumulation of power at the top dead center (absorption of impact energy) and restoration of power at the bottom dead center are not sufficiently carried out, and the effects of improving rotation efficiency or acceleration and of uniformizing rotation torque are insufficient.

Furthermore, since the crank device must be attached to both ends of the gear shaft, the number of parts increases, the entire device becomes complicated and large in size, space-saving and mass productivity lack, torsion of the gear shaft occurs due to phases of the crank at both ends, it is not possible to effectively carry out conversion of accumulation of input energy or accumulated energy into torque, and there is a problem in that durability, operational stability, and efficiency is lacking.

### SUMMARY OF THE INVENTION

The invention was made with respect to the above-described problems, and has an object to provide a rotation transmission mechanism that achieves a bicycle or the like providing more excellent usability than before, a bicycle provided with the rotation transmission mechanism, and an elastically-deformable body used in the rotation transmission mechanism.

In order to solve the above-mentioned conventional problems, the inventor has proposed the bicycle disclosed by Japanese Patent No. 4456179 (hereinbelow, referred to as Patent Document 6). Patent Document 6 provides a bicycle achieving the following purposes.

(1) By arrangement to a rotation shaft of a bicycle that moves when wheels rotate by human power, impact energy or excessive input energy which is generated when initial motion, for example, starting, accelerating, moving on slopes, or the like, or which is due to a large load received from an outside during movement is reliably absorbed, and it is possible to considerably reduce the load applied to a human body.
(2) When input energy is reduced or lost, the accumulated energy can be effectively utilized for rotation of the rotation shaft with zero waste, reliability and efficiency of rotation transmission are excellent, and it is possible to achieve weight saving with a simple configuration in which the number of parts is reduced.
(3) A rotation transmission mechanism used for a bicycle is provided, in which disassembling or assembling is easy, ease of maintenance of or productivity is excellent, incorporation into an existing bicycle is easy, mass productivity, workability of assembly work, space-saving, and general versatility are excellent. Therefore, it is possible to reduce a load applied to foot, lumbar, or the like of a user.
(4) Even when a heavy luggage is carried or a person whose body weight is heavy rides, it is possible to provide excellent acceleration, uniformity in rotation torque, stability at low speed movement, complicated operation is not necessary, and it is possible to reduce the load applied to rider's knees, ankles, or the like.
(5) It is possible to use as an article for daily use, in which, even for a woman, an elderly person, a housewife who handles heavy luggage and put children to a bicycle, or the like, it is possible to simply ride the bicycle and easily move on a sloping road or a road that applies a large load to a rider. It is possible to provide excellent acceleration, uniformity in rotation torque, and stability at low speed movement, use for a course of physiotherapy or for race purposes, and provides excellent stability in operation, handleability, and general versatility.

Particularly, in order to achieve the aforementioned purposes (1) to (5), Patent Document 6 provides “a bicycle including: a rotation transmission mechanism for a bicycle, including an internal rotation member having a rotation shaft and an external rotation member rotatably arranged at the rotation shaft of the internal rotation member; right and left crank arms that are provided at a phase difference of 180 degrees at the both ends of the internal rotation member the rotation transmission mechanism for a bicycle; and pedals rotatably arranged at ends of the crank arms”. Particularly, in this bicycle, the internal rotation member includes one or more outer-peripheral projected portions that are formed integrally with the rotation shaft or fixed to the outer periphery of the rotation shaft and that protrude toward an outer-peripheral side of the rotation shaft, the external rotation member includes: a side plate portion into which the rotation shaft is rotatably inserted at the side positions of the outer-peripheral projected portions of the internal rotation member; an outer casing that is provided upright the outer periphery of the side plate portion in a concentric form with respect to the rotation shaft at the outside of the outer-peripheral projected portions of the internal rotation member; and one or more inner-peripheral projected portions that are formed integrally with the side plate portion and/or the outer casing so as to protrude toward an inner-peripheral side of the outer casing or are fixed to the side plate portion and/or the outer casing and that are alternately arranged with respect to the outer-peripheral projected portions of the internal rotation member, wherein a chain ring is formed at or fixed to the side plate portion of the external rotation member or the outer casing, an elastically-deformable portion is disposed between the inner-peripheral projected portion and the outer-peripheral projected portion that is along the rotational direction of the outer-peripheral projected portions in forward movement, and when the internal rotation member rotates relative to the external rotation member, the elastically-deformable portion is sandwiched between the outer-peripheral projected portion and the inner-peripheral projected portion and is thereby elastically deformed.

The bicycle disclosed by Patent Document 6 achieves the aforementioned purposes (1) to (5); however, the inventor has been conducting earnest research in order to further improve usability of the bicycle disclosed by Patent Document 6 and achieve the invention.

In order to achieve the above-described object, a rotation transmission mechanism according to the first aspect of the invention includes: an internal rotation member into which a rotation shaft is inserted; and an external rotation member rotatably arranged with respect to the internal rotation member, wherein the internal rotation member includes: a disk-shaped internal rotation member main body having a rotation shaft insertion hole; and one or a plurality of outer-peripheral projected portions which are formed integrally with the internal rotation member main body or fixed to the internal rotation member main body and protrude toward an outer-peripheral side of the internal rotation member main body, wherein the external rotation member includes: a circular ring rotatably arranged with respect to the internal rotation member and at an outside of the outer-peripheral projected portions of the internal rotation member; and one or a plurality of inner-peripheral projected portions which are formed integrally with the circular ring or fixed to the circular ring so as to protrude toward an inner-peripheral side of the circular ring and are alternately arranged with respect to the outer-peripheral projected portions of the internal rotation member, wherein the outer-peripheral projected portions have a forward-movement surface that is located at a position displaced from a center of the outer-peripheral projected portion in a forward movement direction in which the rotation transmission mechanism rotates by forward movement, wherein an elastically-deformable portion is disposed between the forward-movement surface and the inner-peripheral projected portion facing the forward-movement surface in the forward movement direction, wherein a space is partially formed in the elastically-deformable portion, and wherein when the internal rotation member rotates relative to the external rotation member, the elastically-deformable portion is sandwiched between the outer-peripheral projected portion and the inner-peripheral projected portion and is thereby elastically deformed.

According to this configuration, the elastically-deformable portion is disposed between the inner-peripheral projected portion and the outer-peripheral projected portion that is along the rotational direction of the outer-peripheral projected portions in forward movement, that is, between the forward-movement surface of the outer-peripheral projected portion and the inner-peripheral projected portion, and a partial space is formed in the elastically-deformable portion. By applying a compressing force to the elastically-deformable portion, compression (elastic) energy accumulated in the elastically-deformable portion is converted into rotational energy and is utilized as, for example, a propulsive force for a bicycle or the like. By forming the partial space in the elastically-deformable portion, it is possible to compress the elastically-deformable portion by a further small force, and it is possible to reduce the weight of the elastically-deformable portion. Additionally, for example, as the elastically-deformable portion is in a tightly sealed state or in a substantially tightly sealed by sandwiching the elastically-deformable portion between side plate portions or the like, air in the partial space is not removed from the inside of the rotation transmission mechanism even where the elastically-deformable portion is compressed, the air itself is compressed, and an elastic force of the elastically-deformable portion can be maintained. Furthermore, for example, by changing the shape or the size of the partial space, it is possible to adjust a force for compressing the elastically-deformable portion. Accordingly, in the case where the rotation transmission mechanism is used for, for example, a bicycle or the like, it is possible to significantly reduce a load on a human body. As a result, it is possible to achieve a bicycle or the like providing more excellent usability than before.

In the rotation transmission mechanism according to the first aspect of the invention, the external rotation member may include a side plate portion and a cover portion, wherein the elastically-deformable portion may be sandwiched between the side plate portion and the cover portion and the space may be in a substantially tightly sealed state.

According to this configuration, the elastically-deformable portion is sandwiched between the side plate portion and the cover portion, therefore the space is substantially in a tightly sealed state, a gas such as air in the space can maintain an appropriate elastic force. In addition, deformation of the elastically-deformable portion in a lateral direction, that is, deformation of the elastically-deformable portion in the axial direction of the rotation transmission mechanism is prevented by the side plate portion and the cover portion, and therefore part of energy is input to the rotation transmission mechanism due to pedaling by a rider can be effectively power-accumulated in the elastically-deformable portion.

In the rotation transmission mechanism according to the first aspect of the invention, the outer-peripheral projected portion may be formed so as to have a shelving inclination relative to an opposite surface on the opposite side of the forward-movement surface, and a curved surface may be formed at a boundary portion between the forward-movement surface and the internal rotation member main body.

According to this configuration, it is possible to lower the height of the outer-peripheral projected portion and to achieve downsizing of the rotation transmission mechanism. Moreover, since the compression distance of the elastically-deformable portion increases in a direction toward the outer-peripheral side, larger compression energy can be accumulated therein.

In the rotation transmission mechanism according to the first aspect of the invention, the elastically-deformable portion may include a main body having a space and a protruding portion provided on a surface of the main body, and the protruding portion may have a shape in plan view which radially expands from the space to the elastically-deformable portion in a radial-outer direction.

According to this configuration, the elastically-deformable portion is prevented from being distorted in a radiation direction of the elastically-deformable portion, and the flat plate shape of the elastically-deformable portion can be maintained while sufficiently power-accumulating energy is input to the rotation transmission mechanism.

In the rotation transmission mechanism according to the first aspect of the invention, the protruding portion of the elastically-deformable portion may have an isosceles triangular shape in cross-sectional view.

According to this configuration, as the isosceles triangle is adopted as the cross-sectional shape of the protruding portion, it is possible to reduce the cost of manufacturing a die of the elastically-deformable portion.

In the rotation transmission mechanism according to the first aspect of the invention, the main body of the elastically-deformable portion may have an upper surface and a lower surface, and the protruding portion may be provided on at least one of the upper surface and the lower surface.

A bicycle according to a second aspect of the invention includes the rotation transmission mechanism according to the aforementioned first aspect.

According to the configuration of the bicycle the invention, since the rotation transmission mechanism that obtains the above-mentioned action and effect is provided, it is possible to provide a bicycle providing more excellent usability than before.

An elastically-deformable body according to a third aspect of the invention is used in the rotation transmission mechanism according to the aforementioned first aspect and includes: a main body having a space; and a protruding portion provided on a surface of the main body, wherein the protruding portion has a shape in plan view which radially expands from the space to the elastically-deformable portion in a radial-outer direction.

### Effects of the Invention

According to the invention, it is possible to provide a rotation transmission mechanism that can achieve a bicycle or the like providing more excellent usability than before.

### BRIEF DESCRIPTION OF THE DRAWINGS

FIG. 1 is a plan view showing a top surface of a rotation transmission mechanism according to a first embodiment of the invention.

FIG. 2 is a plan view showing a back surface of the rotation transmission mechanism according to the first embodiment of the invention.

FIG. 3 is a cross-sectional view taken along the line shown in FIG. 1.

FIG. 4A is a plan view showing an external rotation member constituting the rotation transmission mechanism according to the first embodiment of the invention.

FIG. 4B is a plan view showing a top surface of an internal rotation member constituting the rotation transmission mechanism according to the first embodiment of the invention.

FIG. 4C is a plan view showing a top surface of a cover portion constituting the rotation transmission mechanism according to the first embodiment of the invention.

FIG. 5 is a plan view showing a back surface of the internal rotation member constituting the rotation transmission mechanism according to the first embodiment of the invention.

FIG. 6A is a view showing the top surface of the rotation transmission mechanism according to the first embodiment of the invention and is a plan view showing a state where the cover portion is removed.

FIG. 6B is an enlarged plan view in which the portion indicated by reference letter X shown in FIG. 6A is enlarged.

FIG. 7 is a view showing an example in which the rotation transmission mechanism according to the first embodiment of the invention is used in a bicycle and is a cross-sectional view showing the relevant part of the rotation transmission mechanism.

FIG. 8 is a view showing the top surface of the rotation transmission mechanism according to the first embodiment of the invention and is a plan view showing a state where an elastically-deformable portion is elastically deformed (compressive deformation) in a state where the cover portion is removed.

FIG. 9 is a view showing another example in which the rotation transmission mechanism according to the first embodiment of the invention is used in a bicycle and is a cross-sectional view showing the relevant part of the rotation transmission mechanism.

FIG. 10A is a view showing a state where the cover portion constituting the rotation transmission mechanism of an application example of the first embodiment of the invention is removed and is a plan view showing a state where the elastically-deformable portion is not elastically deformed (compressive deformation).

FIG. 10B is a view showing a state where the cover portion constituting the rotation transmission mechanism of an application example of the first embodiment of the invention is removed and is a plan view showing the top surface in a state where the elastically-deformable portion is elastically deformed (compressive deformation).

FIG. 11 is a plan view showing a top surface of a rotation transmission mechanism according to a second embodiment of the invention.

FIG. 12 is a plan view showing a back surface of the rotation transmission mechanism according to the second embodiment of the invention.

FIG. 13 is a cross-sectional view taken along the line VII-VII shown in FIG. 11.

FIG. 14 is a view showing an example in which the rotation transmission mechanism according to the second embodiment of the invention is used in an electric assist bicycle and is an exploded cross-sectional view showing the relevant part of the rotation transmission mechanism.

FIG. 15 is a view showing an example in which the rotation transmission mechanism according to the second embodiment of the invention is used in the electric assist bicycle and is a cross-sectional view showing the relevant part of the rotation transmission mechanism.

FIG. 16 is a plan view showing a top surface of a rotation transmission mechanism according to a third embodiment of the invention.

FIG. 17 is a plan view showing a back surface of the rotation transmission mechanism according to the third embodiment of the invention.

FIG. 18 is a cross-sectional view taken along the line XVII-XVII shown in FIG. 16.

FIG. 19A is a view showing the rotation transmission mechanism according to the third embodiment of the invention and is a plan view showing a state where the cover portion is removed.

FIG. 19B is an enlarged plan view in which the portion indicated by reference letter Y shown in FIG. 19A is enlarged.

FIG. 20 is a view showing an example in which the rotation transmission mechanism according to the third embodiment of the invention is used in an electric assist bicycle and is an exploded cross-sectional view showing the relevant part of the rotation transmission mechanism.

FIG. 21 is a view showing an example in which the rotation transmission mechanism according to the third embodiment of the invention is used in the electric assist bicycle and is a cross-sectional view showing the relevant part of the rotation transmission mechanism.

FIG. 22 is a view showing the rotation transmission mechanism according to the third embodiment of the invention and is a plan view showing a state where an elastically-deformable portion is elastically deformed (compressive deformation) in a state where the cover portion is removed.

FIG. 23 is a view showing the rotation transmission mechanism according to a fourth embodiment of the invention and is a plan view showing a state where the cover portion is removed.

FIG. 24 is an explanatory diagram for explaining an action of the rotation transmission mechanism according to the fourth embodiment of the invention.

FIG. 25 is a view showing another configuration of the rotation transmission mechanism according to the fourth embodiment of the invention and is a plan view showing a state where the cover portion is removed.

FIG. 26A is a side view showing an elastically-deformable portion according to a fifth embodiment of the invention.

FIG. 26B is a plan view showing an elastically-deformable portion according to the fifth embodiment of the invention.

### DETAILED DESCRIPTION OF THE INVENTION

Hereinafter, the invention will be particularly described with reference to preferred embodiments. However, the following embodiments are examples embodying the invention, and the invention is not limited thereto.

### First Embodiment

### (Configuration of Rotation Transmission Mechanism)

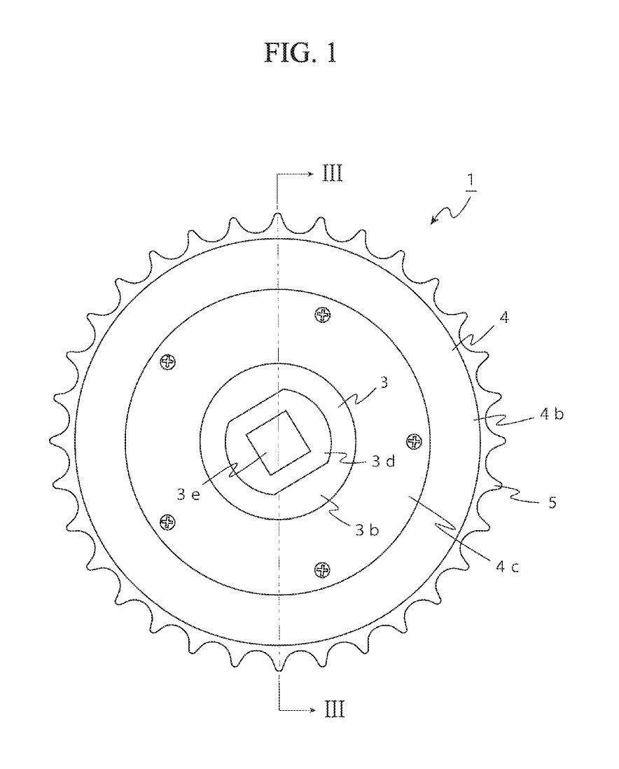

Firstly, a configuration of a rotation transmission mechanism according to a first embodiment of the invention will be described with reference to FIGS. 1 to 6B.

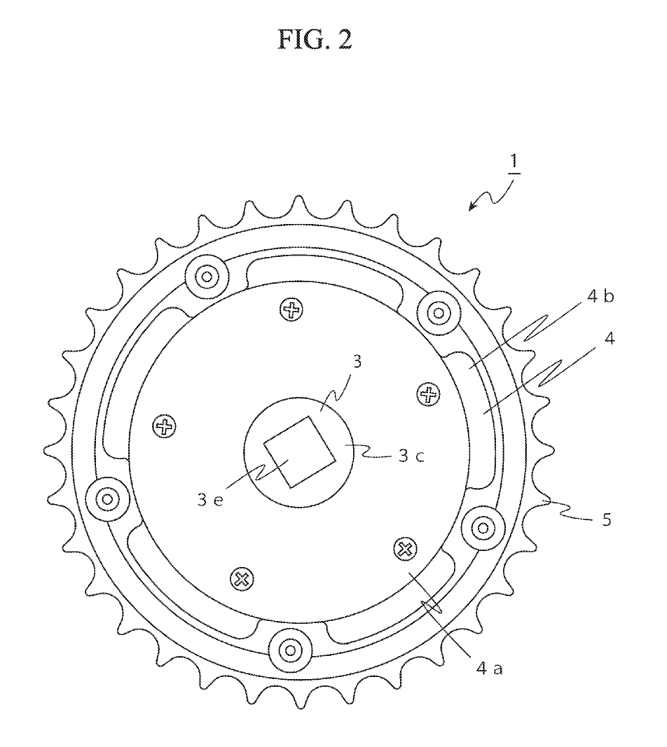

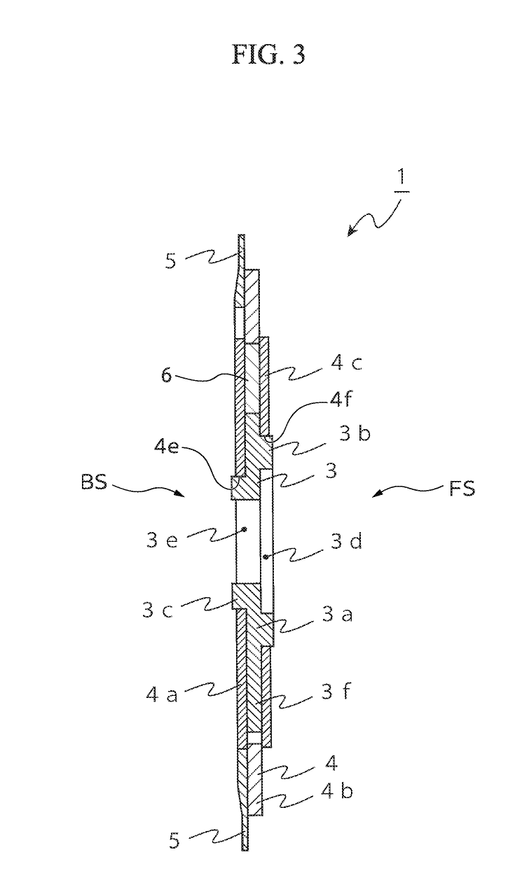

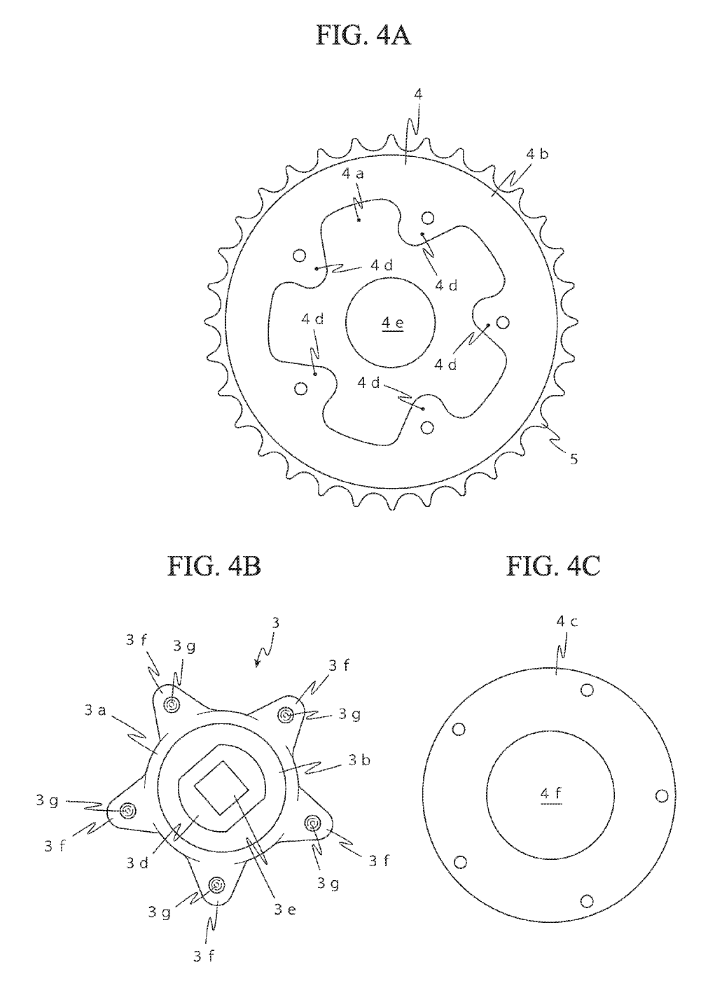

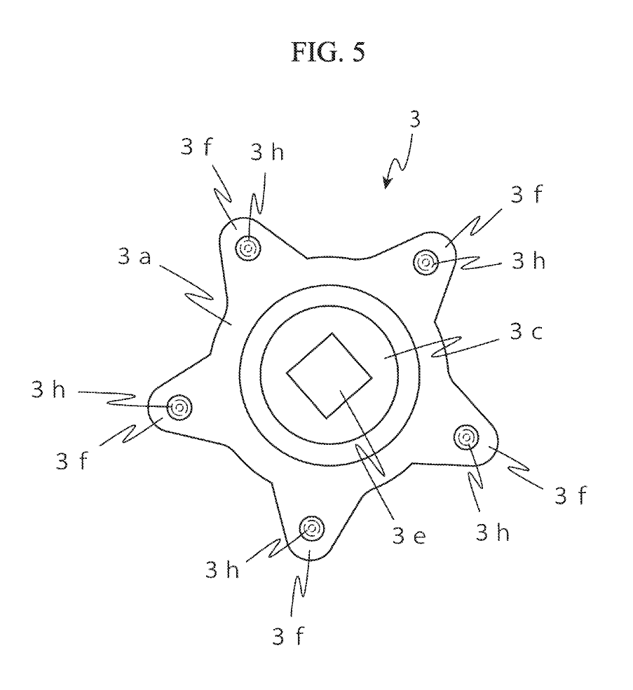

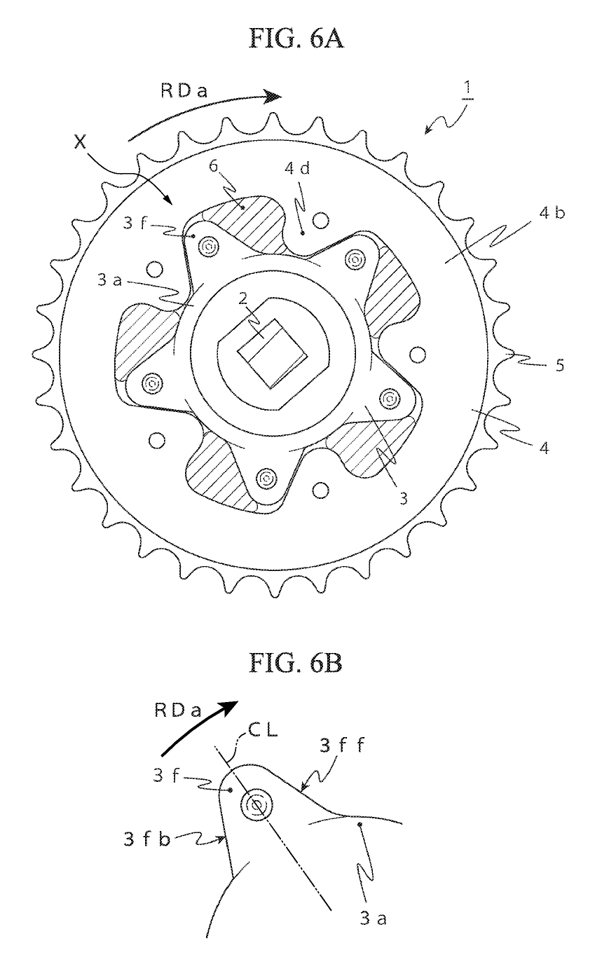

FIG. 1 is a plan view showing a top surface of a rotation transmission mechanism according to a first embodiment of the invention. FIG. 2 is a plan view showing a back surface of the rotation transmission mechanism. FIG. 3 is a cross-sectional view taken along the line shown in FIG. 1. FIG. 4A is a plan view showing the external rotation member constituting the rotation transmission mechanism. FIG. 4B is a plan view showing a top surface of the internal rotation member constituting the rotation transmission mechanism. FIG. 4C is a plan view showing a top surface of a cover portion constituting the rotation transmission mechanism. FIG. 5 is a plan view showing a back surface the internal rotation member constituting the rotation transmission mechanism. FIG. 6A is a view showing the rotation transmission mechanism and is a plan view showing a state where the cover portion is removed. FIG. 6B is an enlarged plan view in which the portion indicated by reference letter X shown in FIG. 6A is enlarged.

In FIG. 3, reference letter FS represents a top surface of the rotation transmission mechanism, and reference letter BS represents a back surface of the rotation transmission mechanism. That is, a plan view represented by reference letter FS corresponds to FIG. 1, and a plan view represented reference letter BS corresponds to FIG. 2.

As shown in FIGS. 1 to 6B, a rotation transmission mechanism 1 according to the embodiment includes, for example, an internal rotation member 3 into which a crankshaft or the like of a bicycle such as a rotation shaft is inserted, an external rotation member 4 rotatably arranged at the internal rotation member 3, and elastically-deformable portions 6 (elastically-deformable body).

### (Internal Rotation Member)

The internal rotation member 3 includes: an internal rotation member main body 3a formed in a disk shape; a cylindrical projected portion 3b formed integrally with a top surface of the internal rotation member main body 3a; a cylindrical projected portion 3c formed integrally with the back surface of the internal rotation member main body 3a; a press-fitting recess 3d formed in the projected portion 3b; a crankshaft insertion hole 3e that is formed in a quadrangle tubular shape, penetrates through the projected portion 3c and the internal rotation member main body 3a, and reaches the press-fitting recess 3d.

As shown in FIG. 3, the height of the projected portion 3b that protrudes from the top surface of the internal rotation member main body 3a (distance from the top surface of the internal rotation member main body 3a to the end surface of the projected portion 3b in the direction of the crankshaft) is larger than the thickness of a cover portion 4c which will be described later.

Additionally, the height of the projected portion 3c that protrudes from the back surface of the internal rotation member main body 3a (distance from the back surface of the internal rotation member main body 3a to the end surface of the projected portion 3c in the direction of the crankshaft) is larger than a thickness of a side plate portion 4a which will be described later.

The press-fitting recess 3d has a substantially oval shape as shown in FIG. 4B and a depth substantially corresponding to the height of the projected portion 3b as shown in FIG. 3.

Additionally, the internal rotation member 3 includes five outer-peripheral projected portions 3f that are formed integrally with the internal rotation member main body 3a and protrude from the outer-periphery of the internal rotation member main body 3a to the outside. Bearing balls 3g and 3h are rotatably held by the top surface and the back surface of the outer-peripheral projected portions 3f, respectively. In the radial direction of the internal rotation member 3 (in the centrifugal direction from the crankshaft as a center), the balls 3g and 3h are located at the position at 45 to 65% with respect to the protrusion amount (length) of the outer-peripheral projected portion 3f, preferably, at the position at 58 to 62%. In other words, where the distance from the outer peripheral face of the internal rotation member main body 3a to the outer end of the outer-peripheral projected portion 3f in the radial direction of the internal rotation member 3 is 100%, the balls 3g and 3h are provided at the position at 45 to 65%, preferably, 58 to 62% far from the outer peripheral face of the internal rotation member main body 3a.

As shown in FIG. 6B, each of the outer-peripheral projected portions 3f has a forward-movement surface 3ff and an opposite surface 3fb located on the opposite side of the forward-movement surface 3ff. In other words, the forward-movement surface 3ff is located at the position that is displaced from the center line CL of the outer-peripheral projected portion 3f in the radial direction of the internal rotation member 3 along the rotational direction RDa (forward movement direction, the rotational direction of the rotation transmission mechanism 1 in a case where a bicycle moves forward), that is, the forward-movement surface is located at the right side position of the outer-peripheral projected portion 3f in FIG. 6B. On the other hand, the opposite surface 3fb is located at the position that is displaced from the center line CL of the outer-peripheral projected portion 3f in the radial direction of the internal rotation member 3 along the opposite direction relative to the rotational direction RDa, that is, the opposite surface is located at the left side position of the outer-peripheral projected portion 3f in FIG. 6B.

### (External Rotation Member)

The external rotation member 4 includes a side plate portion 4a, a circular ring 4b, and a cover portion 4c. The side plate portion 4a is located at the side portion of the outer-peripheral projected portion 3f of the internal rotation member 3 and is rotatable relative to the projected portion 3c of the internal rotation member 3. An insertion hole 4e is formed in the side plate portion 4a, and the projected portion 3c is inserted into the insertion hole 4e. The circular ring 4b is screwed to the outer periphery of the side plate portion 4a at the outside of the outer-peripheral projected portions 3f of the internal rotation member 3. The cover portion 4c is rotatable relative to the projected portion 3b in a state of being disposed so as to face the side plate portion 4a. An insertion hole 4f is formed in the cover portion 4c, and the projected portion 3b is inserted into the insertion hole 4f. The cover portion 4c is screwed to the circular ring 4b.

Note that, the internal rotation member 3 rotates while the bearing balls 3g and 3h held by the top surface and the back surface of the outer-peripheral projected portion 3f roll on the cover portion 4c and the side plate portion 4a, respectively. By means of this structure, it is possible to smoothly rotate the internal rotation member 3.

Furthermore, the external rotation member 4 includes five inner-peripheral projected portions 4d. The inner-peripheral projected portions 4d are formed integrally with the circular ring 4b so as to protrude toward the inner-peripheral side of the circular ring 4b and are arranged alternately with the outer-peripheral projected portions 3f of the internal rotation member 3. Specifically, a plurality of the inner-peripheral projected portions 4d and a plurality of the outer-peripheral projected portions 3f are arranged so that one outer-peripheral projected portion 3f is disposed between the inner-peripheral projected portions 4d adjacent to each other and one inner-peripheral projected portion 4d is disposed between the outer-peripheral projected portions 3f adjacent to each other in the rotational direction of the rotation transmission mechanism 1.

Moreover, a chain ring 5 is fixed to the outer-periphery of the back surface side of the circular ring 4b of the external rotation member 4.

### (Elastically-Deformable Portion)

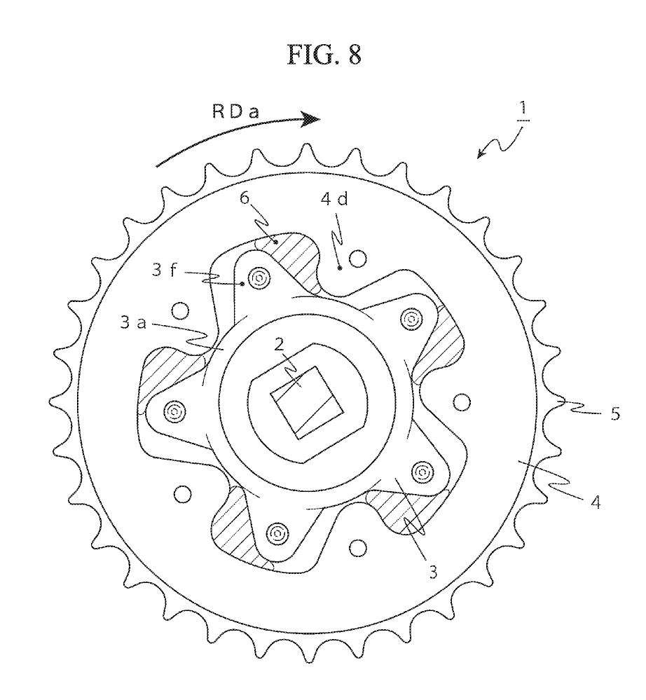

As shown in FIG. 3, the elastically-deformable portion 6 is made of an elastic member such as synthetic rubber and can be elastically deformed. The elastically-deformable portion 6 is sandwiched between the cover portion 4c and the side plate portion 4a and is surrounded by the circular ring 4b. As described later, each of the elastically-deformable portions 6 is held between the forward-movement surface 3ff of the outer-peripheral projected portion 3f and the inner-peripheral projected portion 4d that faces the forward-movement surface 3ff in the rotational direction RDa. Note that, the number of elastically-deformable portions 6 shown in FIGS. 6A and 8 is five; however, the number of elastically-deformable portions 6 is not limited. The elastically-deformable portion 6 transmits torque from the external rotation member 4 to the internal rotation member 3 while being elastically deformed. Furthermore, the elastically-deformable portions 6 transmit, as torque, power-accumulated energy in the elastically-deformable portions 6 to the internal rotation member 3.

The rotation transmission mechanism 1 is assembled in the following sequence. In particular, firstly, as shown in FIGS. 2 and 3, the side plate portion 4a is screwed to the circular ring 4b from the back surface side of the circular ring 4b. Next, as shown in FIGS. 3, 4A to 4C, and 6A, the projected portion 3c located at the back surface side of the internal rotation member 3 is inserted into the insertion hole 4e of the side plate portion 4a in a direction from the top surface side FS of the side plate portion 4a to the back surface side BS thereof. Consequently, the internal rotation member 3 is disposed inside the circular ring 4b. Subsequently, as shown in FIGS. 1, 3, and 4A to 4C, the projected portion 3b located at the top surface side of the internal rotation member 3 is inserted into the insertion hole 4f of the cover portion 4c, and the cover portion 4c is screwed to the top surface of the circular ring 4b.

(Contact Configuration of Elastically-Deformable Portion with Respect to Outer-Peripheral Projected Portion and Inner-Peripheral Projected Portion)

As shown in FIGS. 6A and 6B, the elastically-deformable portion 6 is provided between the forward-movement surface 3ff of the outer-peripheral projected portion 3f and the inner-peripheral projected portion 4d. In other words, the elastically-deformable portion 6 is disposed between the outer-peripheral projected portion 3f and the inner-peripheral projected portion 4d that is located at the position along the rotational direction from the outer-peripheral projected portion 3f when a bicycle moves forward (when the rotation transmission mechanism 1 rotates in the rotational direction RDa). When the internal rotation member 3 and the external rotation member 4 relatively rotate, the elastically-deformable portion 6 is configured so to be sandwiched between the outer-peripheral projected portion 3f and the inner-peripheral projected portion 4d and thereby elastically deformed (compressive deformation). Here, deformation of the elastically-deformable portion 6 in a lateral direction, that is, deformation of the elastically-deformable portion 6 in the axial direction of the rotation transmission mechanism 1 shown in FIG. 3 is prevented by the side plate portion 4a and the cover portion 4c, and therefore part of energy is input to the rotation transmission mechanism 1 due to pedaling by a rider can be effectively power-accumulated in the elastically-deformable portion 6.

As shown in FIG. 6B, in the rotation transmission mechanism 1 according to the embodiment, the area of the surface (the forward-movement surface 3ff) directed in the rotational direction of the outer-peripheral projected portion 3f is larger by approximately 10 to 15%, preferably approximately 12 to 13%, than the area of the surface (the opposite surface 3fb, the surface located at the position that is displaced from the center line CL along the opposite direction relative to the rotational direction) directed in the direction opposite to the rotational direction. Accordingly, the elastically-deformable portion 6 placed between the outer-peripheral projected portion 3f and the inner-peripheral projected portion 4d that is located at the position along the rotational direction from the outer-peripheral projected portion 3f when a bicycle moves forward (between the forward-movement surface 3ff and the inner-peripheral projected portion 4d) is compressively deformed at a larger area (range) than before, and it is possible to effectively accumulate compression (elastic) energy in the elastically-deformable portion 6. The compression (elastic) energy is converted into rotational energy and is utilized as a propulsive force for a bicycle or the like.

More particularly, the outer-peripheral projected portion 3f is formed so that the forward-movement surface 3ff (the surface directed in the rotational direction) has a shelving inclination relative to the opposite surface 31fb (the surface directed in the direction opposite to the rotational direction). Furthermore, a curved surface that continuously connects the forward-movement surface 3ff and the outer peripheral face of the internal rotation member main body 3a is formed at the boundary portion between the forward-movement surface 3ff (the surface directed in the rotational direction) and the internal rotation member main body 3a. As a result of adopting the foregoing configuration, the height of the outer-peripheral projected portion 3f (the distance from the outer peripheral face of the internal rotation member main body 3a to the outer end of the outer-peripheral projected portion 3f) can be lowered by making the surface area of the forward-movement surface 3ff of the outer-peripheral projected portion 3f (the surface directed in the rotational direction) larger, and it is possible to achieve downsizing of the rotation transmission mechanism 1. Moreover, since the length of the outer-peripheral projected portion 3f (the forward-movement surface 3ff) that compresses the elastically-deformable portion 6 increases in a direction from the outer peripheral face of the internal rotation member main body 3a toward the outer end of the outer-peripheral projected portion 3f, larger compression energy can be accumulated therein.

Additionally, by adjusting the thickness of the circular ring 4b, it is possible to adjust a centrifugal force when the rotation transmission mechanism 1 rotates, and therefore it is possible to adjust the inertial force of rotation.

The surface of the inner-peripheral projected portion 4d which faces the forward-movement surface 3ff of the outer-peripheral projected portion 3f (the surface directed in the rotational direction) is formed in a state of being depressed. For this reason, it is possible to increase the amount of the elastically-deformable portion 6 placed between the outer-peripheral projected portion 3f and the inner-peripheral projected portion 4d that is located at the position along the rotational direction from the outer-peripheral projected portion 3f when a bicycle moves forward (between the forward-movement surface 3ff and the inner-peripheral projected portion 4d). Consequently, it is possible to accumulate, the elastically-deformable portion 6, a sufficient amount of compression (elastic) energy to be used as a propulsive force. The volume of the inside space of the recess formed by being depressed is preferably 2 to 5% of the volume of the elastically-deformable portion 6. This is because, if the recess is excessively large, compression of the elastically-deformable portion 6 becomes insufficient.

### (Usage Example of Rotation Transmission Mechanism)

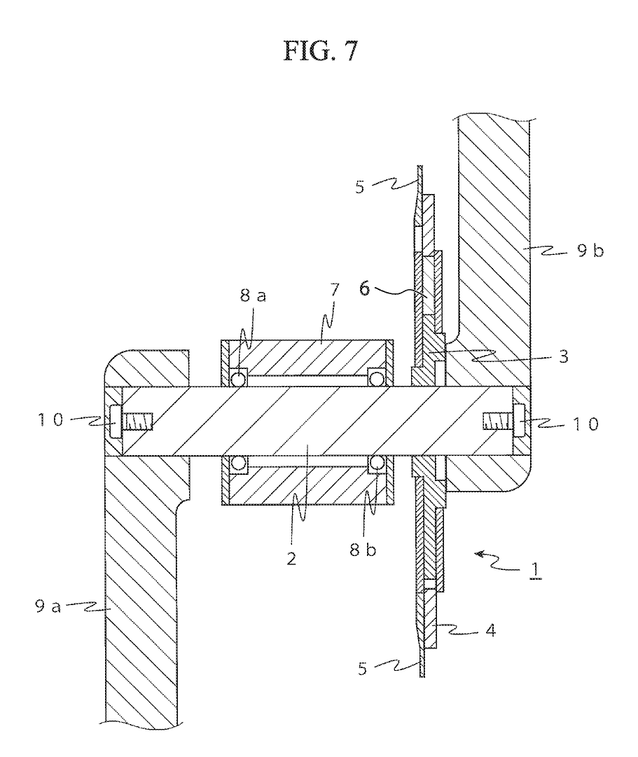

Next, usage example of the rotation transmission mechanism 1 according to the embodiment will be described with reference to FIGS. 7 and 8.

FIG. 7 is a view showing an example in which the rotation transmission mechanism according to the first embodiment of the invention is used in a bicycle and is a cross-sectional view showing the relevant part of the rotation transmission mechanism, and FIG. 8 is a view showing the rotation transmission mechanism and is a plan view showing a state where the elastically-deformable portion is elastically deformed (compressive deformation) in a state where the cover portion 4c is removed.

As shown in FIG. 7, a crankshaft 2 of a bicycle serving as a rotation shaft is rotatably held by a crankshaft holder 7 integrated with a frame of the bicycle via right and left ball bearings 8a and 8b. The right end of the crankshaft 2 is inserted into and fixed to the crankshaft insertion hole 3e of the internal rotation member 3 (refer to FIG. 3), and therefore the rotation transmission mechanism 1 is attached to the crankshaft 2. In addition, crank arms 9a and 9b are fixed at a phase difference of 180 degrees to both right and left ends of the crankshaft 2. In FIG. 7, reference numeral 10 represents a crank arm fixing member that is used to fix the crank arms 9a and 9b to the crankshaft 2. The crankshaft 2 is fitted into a quadrangle tube of the crankshaft insertion hole 3e of the internal rotation member 3 and they integrally rotate.

Rotatable pedals (not shown in the figure) are provided at the ends of the crank arms 9a and 9b.

An action of the rotation transmission mechanism 1 attached to the crankshaft 2 of the bicycle as described above will be described with reference to FIGS. 6A and 8.

In FIG. 7, when a rider steps the pedals (not shown in the figure) disposed at the ends of the crank arms 9a and 9b, the crankshaft 2 and the outer-peripheral projected portions 3f that is provided to protrude toward the outer periphery of the internal rotation member main body 3a rotate in the direction of the arrow RDa in FIGS. 6A and 8.

Subsequently, when the crankshaft 2 rotates and the outer-peripheral projected portion 3f comes close to the inner-peripheral projected portion 4d, the elastically-deformable portion 6 is compressed by being sandwiched between the outer-peripheral projected portion 3f (the forward-movement surface 3ff) and the inner-peripheral projected portion 4d, and part of input energy is accumulated in the elastically-deformable portion 6.

When the crankshaft 2 initially rotates (from FIG. 6A to FIG. 8), the elastically-deformable portion 6 is elastically deformed; however, after the elastically-deformable portion 6 is deformed, torque of the crankshaft 2 is transmitted from the outer-peripheral projected portion 3f to the inner-peripheral projected portion 4d, and the crankshaft 2 and the chain ring 5 rotate as being a substantially integrated body. Torque is reliably transmitted to a sprocket provided at the rear wheel side of a bicycle via a chain (not shown in the figure) provided on the chain ring 5 in a tensioned state.

The elastically-deformable portion 6 elastically deformed (compressive deformation) restores when energy input from the pedals to the rotation transmission mechanism 1 is stopped or weakened, presses the inner-peripheral projected portion 4d as restoring energy, and causes the external rotation member 4 and the chain ring 5 to rotate in a traveling direction. That is, compression (elastic) energy of the elastically-deformable portion 6 is converted into rotational energy and utilized as a propulsive force for a bicycle.

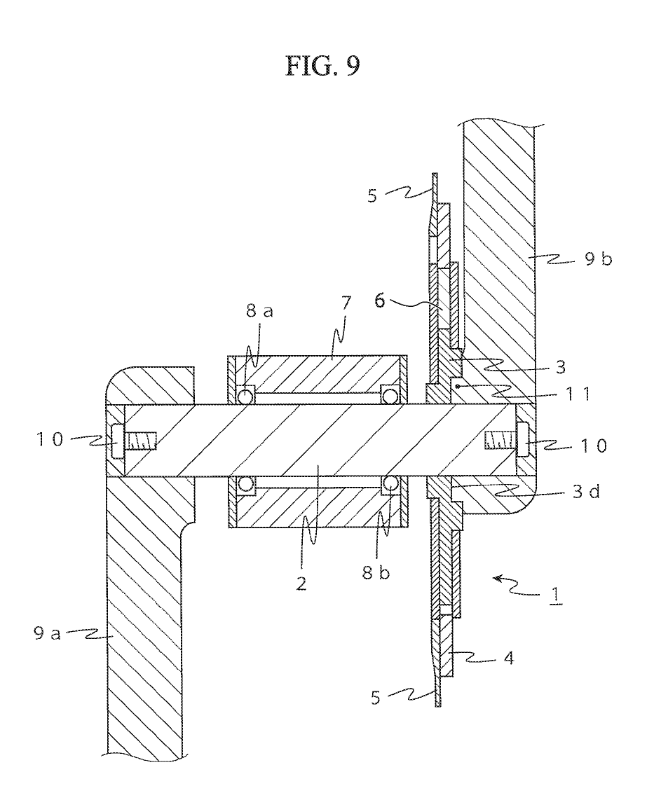

Note that, in the embodiment, the case where the crank arms 9a and 9b are only fixed to both right and left ends of the crankshaft 2 is described as an example; however, the invention is not limited to the above-described configuration. For example, as shown in FIG. 9, a press-fitting projected portion 11 is provided on the surface of the crank arm 9b which faces the rotation transmission mechanism 1, the press-fitting projected portion 11 is pressed into the press-fitting recess 3d of the internal rotation member 3, and the crank arm 9b may be fixed to fixed to the right end of the crankshaft 2. According to this configuration, since it is possible to completely incorporate the crank arm 9b and the internal rotation member 3 in an integrated manner, a stepping action of the pedals can be reliably converted into a rotational action of the outer-peripheral projected portion 3f of the internal rotation member 3.

Moreover, in the embodiment, the case where five outer-peripheral projected portions 3f and five inner-peripheral projected portions 4d are provided is described as an example; however, the invention is not limited to the above-described configuration. It is only necessary that the number of outer-peripheral projected portions 3f and the number of inner-peripheral projected portions 4d are each one or more. In order to transmit the force accumulated in the elastically-deformable portions 6 to them in the circumferential direction, it is preferable that the number of outer-peripheral projected portions 3f and the number of inner-peripheral projected portions 4d be greater than or equal to four. Furthermore, in order to sufficiently ensure the volume of the elastically-deformable portion 6, it is preferable that each of the numbers of the outer-peripheral projected portions 3f and the inner-peripheral projected portions 4d be less than or equal to eight.

Moreover, in the embodiment, the case where the outer-peripheral projected portions 3f are formed integrally with the internal rotation member main body 3a is described as an example; however, the invention is not limited to the above-described configuration. The outer-peripheral projected portions may be fixed to the internal rotation member main body.

Furthermore, in the embodiment, the case where the inner-peripheral projected portions 4d are formed integrally with the circular ring 4b is described as an example; however, the invention is not limited to the above-described configuration. The inner-peripheral projected portion may be fixed to the circular ring.

Moreover, in the embodiment, the case where the elastically-deformable portions 6 are made of synthetic rubber is described as an example; however, the invention is not limited to the above-described configuration.

It is only necessary that the elastically-deformable portion is elastically deformed (compressive deformation) when the internal rotation member 3 and the external rotation member 4 relatively rotate and that after the deformation, the elastically-deformable portion can transmit rotation between the internal rotation member 3 and the external rotation member 4. The shape, size, deformation amount, coefficient of elasticity, or the like of the elastically-deformable portion can be appropriately selected depending on a user's preference. As the elastically-deformable portion, not only synthetic rubber but also a gas or the like sealed between, for example, the outer-peripheral projected portion 3f and the inner-peripheral projected portion 4d can be used.

### Application Example of First Embodiment

A space is partially formed in the elastically-deformable portion.

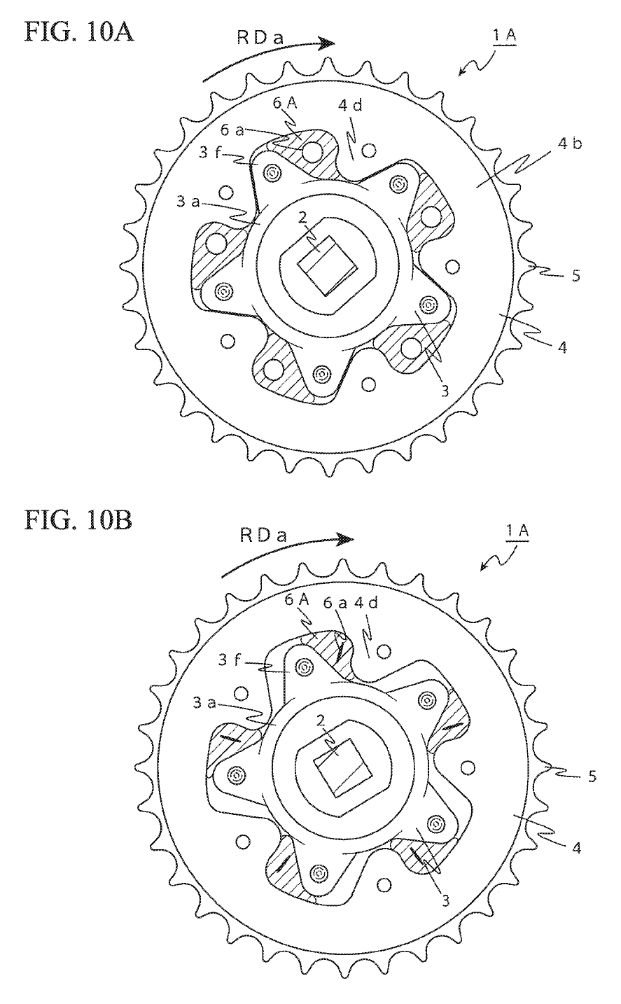

FIGS. 10A and 10B are plan views showing a state where the cover portion constituting the rotation transmission mechanism of an application example of the first embodiment of the invention is removed. FIG. 10A is a plan view showing a state where the elastically-deformable portion is not elastically deformed (compressive deformation). FIG. 10B is a plan view showing a state where the elastically-deformable portion is elastically deformed (compressive deformation).

The rotation transmission mechanism 1A shown in FIGS. 10A and 10B according to the application example of the first embodiment different in the configuration of the elastically-deformable portion from the rotation transmission mechanism 1 according to the aforementioned first embodiment (refer to FIG. 6A, 6B, 8, or the like). Therefore, identical reference numerals are used for the constituent members which are identical to those of the rotation transmission mechanism 1 according to the above-described first embodiment, and the explanations thereof are omitted here.

Spaces 6a are partially formed in elastically-deformable portions 6A (elastically-deformable body) of a rotation transmission mechanism 1A.

In the example shown in FIG. 10A, the space 6a is a through hole that extends in the same direction as that of the crankshaft 2 at a substantially center of the elastically-deformable portion 6A. The size of the space 6a may be adjusted depending on a force (a load to rotate the rotation transmission mechanism 1A) that desirably and elastically deforms (compressive deformation) the elastically-deformable portion 6A. For example, the area of the space 6a (as seen in the direction in which the crankshaft 2 extends) is greater than or equal to 20% of the area of the elastically-deformable portion 6A and is less than or equal to five square centimeters. The entire elastically-deformable portion 6A in the case where the space 6a does not exist therein is compressed when being compressed. As the space 6a exists, the elastically-deformable portion 6A partially receives a stress when being compressed. Accordingly, when the ratio of the size of the space to the area of the elastically-deformable portion 6A is large, there increasingly is an advantage in weight saving. However, when the space is excessively large, deformation due to the above-described stress becomes significantly large, and it becomes a factor of degradation in the elastically-deformable portion 6A. Additionally, a cross-sectional area of the elastically-deformable portion 6A is excessively large, when being compressed, it is not possible to confine air in the inside thereof. In the case of applying this rotation transmission mechanism 1 to a bicycle, it is enough that air is confined at approximately 0.1 second at a usual rate of rotation for when pedaling, in order for this, it is preferable that an opening space be less than or equal to five square centimeters, desirably, less than or equal to three square centimeters. Furthermore, a member having a coefficient of elasticity different from that of the elastically-deformable portion 6A may be inserted into the space 6a.

Note that, the space 6a is not limited to a through hole and may be formed in a hole shape, a recess shape, or the like, which is formed by partially cutting out the elastically-deformable portion 6A; in this case, air is likely to be confined in the inside thereof when compression, and air itself is easy to function as a medium to be elastically deformed.

Additionally, as seen in the direction in which the crankshaft 2 extends, the space 6a may be formed in an arbitrary shape such as an elliptical shape, a circular shape, or polygonal shape. That is, as long as its shape is a true circle as seen in the direction in which the crankshaft 2 extends, the elastically-deformable portion 6A is uniformly deformed even when being compressed in any directions, and therefore it is most preferable; however, it may be an elliptical shape, a polygonal shape, or the like. In this case, it is preferable that a portion be formed which is parallel to the surface at which the outer-peripheral projected portion 3f and the inner-peripheral projected portion 4d are in contact with the elastically-deformable portion. In this case, while a space is formed in a shape corresponding to the entire shape of the elastically-deformable portion 6A, it is possible to uniformly apply a compression force to the elastically-deformable portion 6A. Additionally, the number of spaces 6a is not only one but also two or more.

When the crankshaft 2 rotates (in the rotational direction RDa) from the state shown in FIG. 10A, the outer-peripheral projected portion 3f comes close to the inner-peripheral projected portion 4d, the elastically-deformable portion 6 is compressed by being sandwiched between the outer-peripheral projected portion 3f and the inner-peripheral projected portion 4d, at this time, the space 6a is squashed, and it becomes the state shown in FIG. 10B is obtained.

In the rotation transmission mechanism 1A according to the application example of the first embodiment, the partial space 6a is formed in the elastically-deformable portion 6A placed between the outer-peripheral projected portion 3f and the inner-peripheral projected portion 4d that is located at the position along the rotational direction from the outer-peripheral projected portion 3f when a bicycle moves forward (between the forward-movement surface 3ff and the inner-peripheral projected portion 4d). By applying a compressing force to the elastically-deformable portion 6A, compression (elastic) energy accumulated in the elastically-deformable portion 6A is converted into rotational energy and is utilized as, for example, a propulsive force for a bicycle or the like. By forming the partial space 6a in the elastically-deformable portion 6A, it is possible to compress the elastically-deformable portion by a further small force, and it is possible to reduce the weight of the elastically-deformable portion 6A. Additionally, for example, as the elastically-deformable portion 6A is in a tightly sealed state or in a substantially tightly sealed by sandwiching both ends of the elastically-deformable portion 6A in the axial direction of the rotation transmission mechanism 1A by the side plate portion 4a, the cover portion 4c, or the like, even where the elastically-deformable portion 6A is compressed, the air itself is compressed without removing air in the partial space 6a from the inside of the rotation transmission mechanism 1A, and an elastic force of the elastically-deformable portion 6A can be maintained. Furthermore, for example, by changing the shape or the size of the partial space 6a, it is possible to adjust a force for compressing the elastically-deformable portion 6A. Accordingly, in the case where the rotation transmission mechanism 1A is used for, for example, a bicycle or the like, it is possible to significantly reduce a load on a human body. As a result, it is possible to achieve a bicycle or the like providing more excellent usability than before.

Furthermore, in the embodiment or the application example, the rotation transmission mechanism 1 used in a bicycle is described as an example; however, the rotation transmission mechanism according to the invention is not limited to the above-described intended use. The rotation transmission mechanism according to the embodiment of the invention is applicable to a general mechanism having a wheel, for example, is applicable to not only a mechanism having a wheel such as a unicycle used for civil engineering, a wheelchair, a rickshaw, or a rear car but also a robot, a power generator, or the like, and it is possible to obtain the same action and effect as those of the above.

### Second Embodiment

### (Configuration of Rotation Transmission Mechanism)

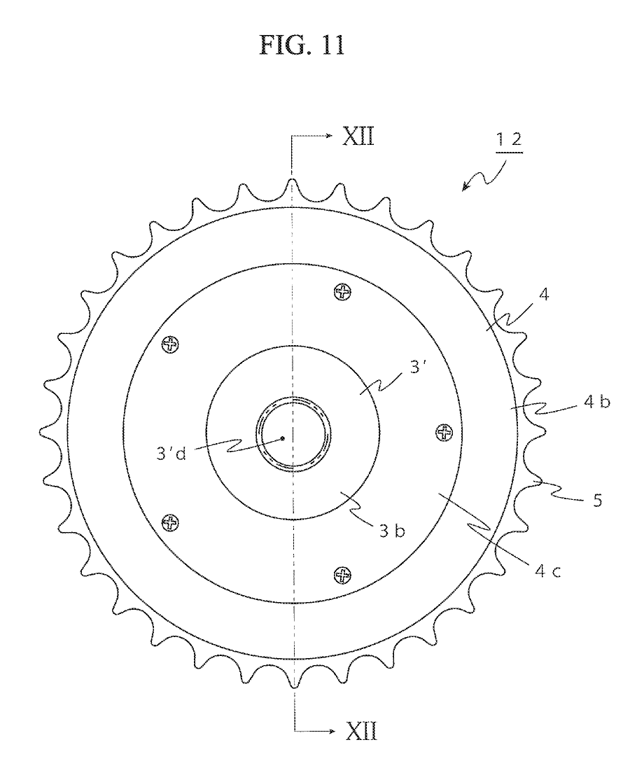

Next, a configuration of a rotation transmission mechanism according to a second embodiment of the invention will be described with reference to FIGS. 11 to 13.

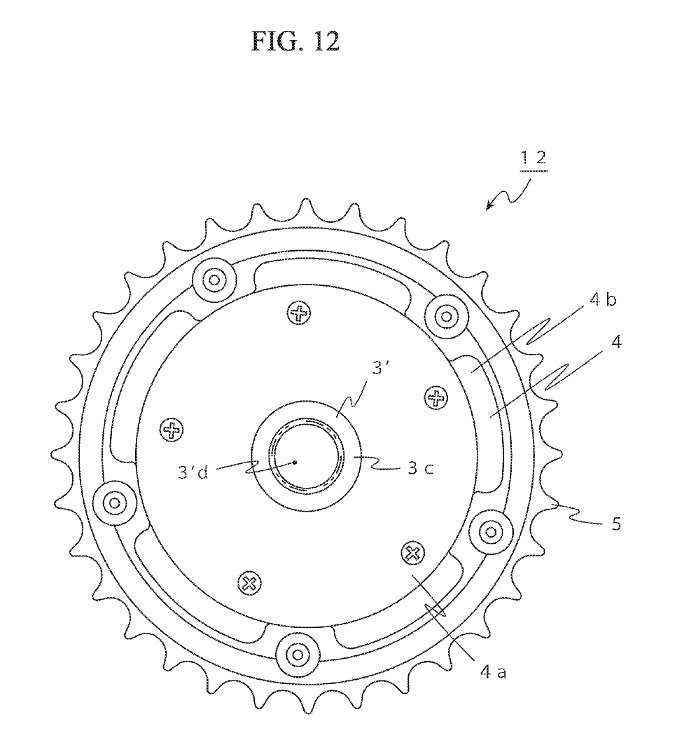

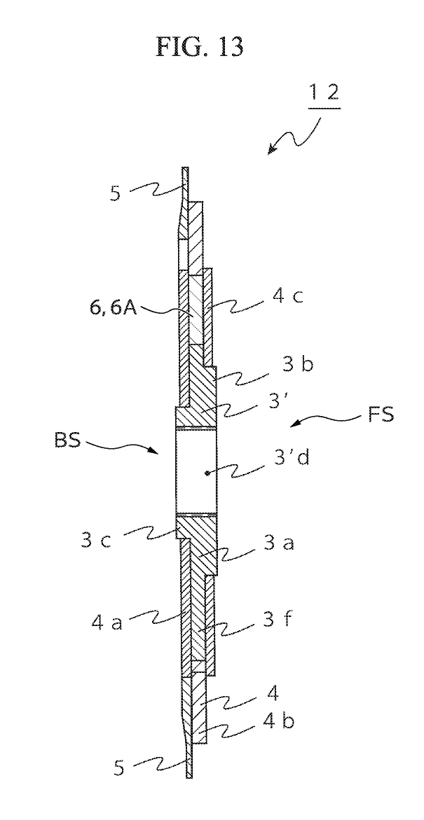

FIG. 11 is a plan view showing a top surface of a rotation transmission mechanism according to the second embodiment of the invention, FIG. 12 is a plan view showing a back surface of the rotation transmission mechanism, and FIG. 13 is a cross-sectional view taken along the line VII-VII shown in FIG. 11.

In FIG. 13, reference letter FS represents a top surface of the rotation transmission mechanism, and reference letter BS represents a back surface of the rotation transmission mechanism. That is, a plan view represented by reference letter FS corresponds to FIG. 11, and a plan view represented reference letter BS corresponds to FIG. 12.

The rotation transmission mechanism 12 according to the embodiment shown in FIGS. 11 to 13 is different from the aforementioned rotation transmission mechanism 1 according to the first embodiment (refer to FIGS. 1 to 3 or the like) in the configuration of the internal rotation member. Therefore, identical reference numerals are used for the constituent members which are identical to those of the rotation transmission mechanism 1 according to the above-described first embodiment, and the explanations thereof are omitted here.

As shown in FIGS. 11 to 13, an internal rotation member 3′ of the rotation transmission mechanism 12 according to the embodiment includes: the internal rotation member main body 3a formed in a disk shape; the cylindrical projected portion 3b formed integrally with the top surface of the internal rotation member main body 3a; the cylindrical projected portion 3c formed integrally with the back surface of the internal rotation member main body 3a; and a spline hole 3′d formed so as to penetrate through the projected portion 3b, the internal rotation member main body 3a, and the projected portion 3c.

Moreover, the internal rotation member 3′ includes five outer-peripheral projected portions 3f that are formed integrally with the internal rotation member main body 3a and protrude from the outer-periphery of the internal rotation member main body 3a to the outside. Bearing balls 3g and 3h are rotatably held by the top surface and the back surface of the outer-peripheral projected portions 3f, respectively (refer to FIGS. 4A to 5).

### (Usage Example of Rotation Transmission Mechanism)

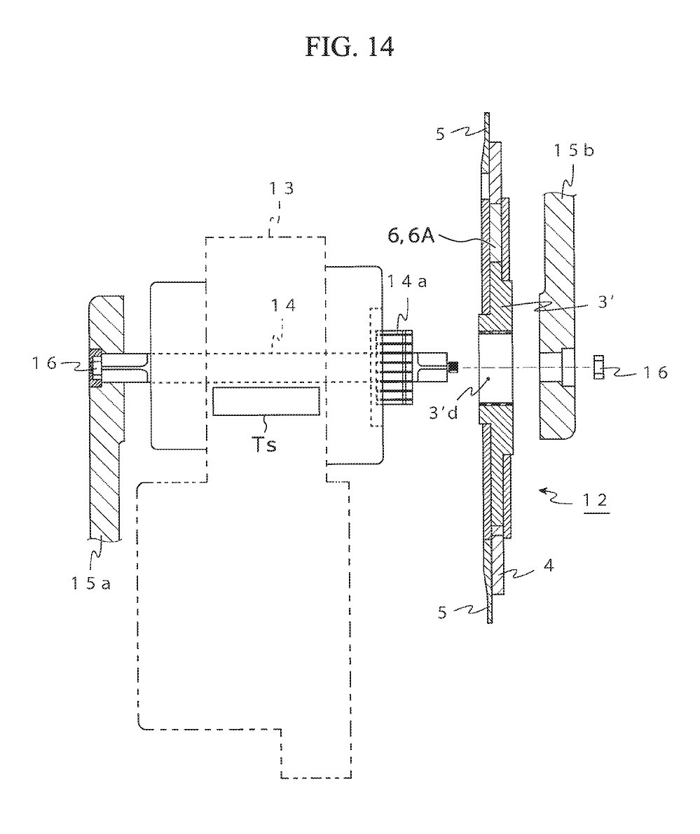

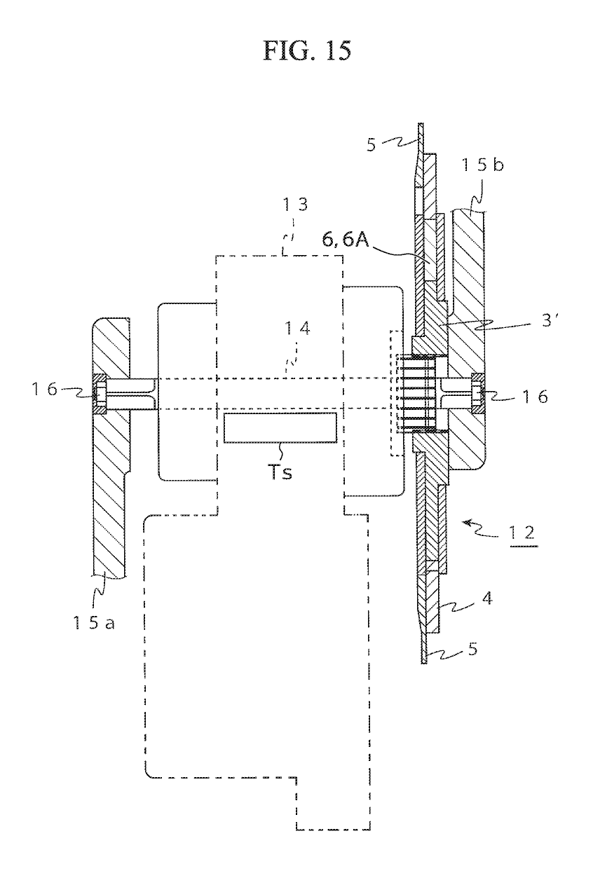

Next, usage example of the rotation transmission mechanism 12 according to the embodiment will be described with reference to FIGS. 14 and 15.

FIG. 14 is a view showing an example in which the rotation transmission mechanism according to the second embodiment of the invention is used in an electric assist bicycle and is an exploded cross-sectional view showing the relevant part of the rotation transmission mechanism. FIG. 15 is a view showing an example in which the rotation transmission mechanism is used in the electric assist bicycle and is a cross-sectional view showing the relevant part of the rotation transmission mechanism.

The rotation transmission mechanism 12 according to the embodiment is attached to a crankshaft of the electric assist bicycle and used therefor.

As shown in FIGS. 14 and 15, a crankshaft 14 that penetrates through right and left portions of a motor driving unit 13 and serves as a rotation shaft is rotatably held by the motor driving unit 13 of the electric assist bicycle. A spline 14a fitted into the spline hole 3′d of the internal rotation member 3′ is fixed to the right end of the crankshaft 14 in a concentric form with respect to the crankshaft 14. By inserting the spline 14a into the spline hole 3′d of the internal rotation member 3′, the rotation transmission mechanism 12 is attached to the right end of the crankshaft 14. In addition, crank arms 15a and 15b are fixed at a phase difference of 180 degrees to both right and left ends of the crankshaft 14. In FIGS. 14 and 15, reference numeral 16 represents a crank arm fixing member that is used to fix the crank arms 15a and 15b to the crankshaft 14.

Rotatable pedals (not shown in the figure) are provided at the ends of the crank arms 15a and 15b.

A torque sensor is disposed at the position close to the crankshaft 14 in the motor driving unit 13, and the torque sensor can detect human driving power due to a leg force which is input to the motor driving unit 13 from the pedal. Therefore, the motor is driven in accordance with the detection result of the torque sensor, and it is possible to assist rotation of the crankshaft 14 (auxiliary driving power).

The action of the rotation transmission mechanism 12 attached to the crankshaft 14 of the electric assist bicycle as described above is substantially the same as that of the case of the aforementioned first embodiment. However, unlike the case of the above-mentioned first embodiment, the human driving power due to a leg force which is input to the motor driving unit 13 from the pedal is detected by the torque sensor, and auxiliary driving power (assist force) of the motor corresponding to the human driving power is applied. Consequently, it is possible to easily ride even steep slopes. Accordingly, as the rotation transmission mechanism according to the invention is attached to and used for the crankshaft of the electric assist bicycle as described above, it is possible to significantly relieve the rider's fatigue.

### Third Embodiment

### (Configuration of Rotation Transmission Mechanism)

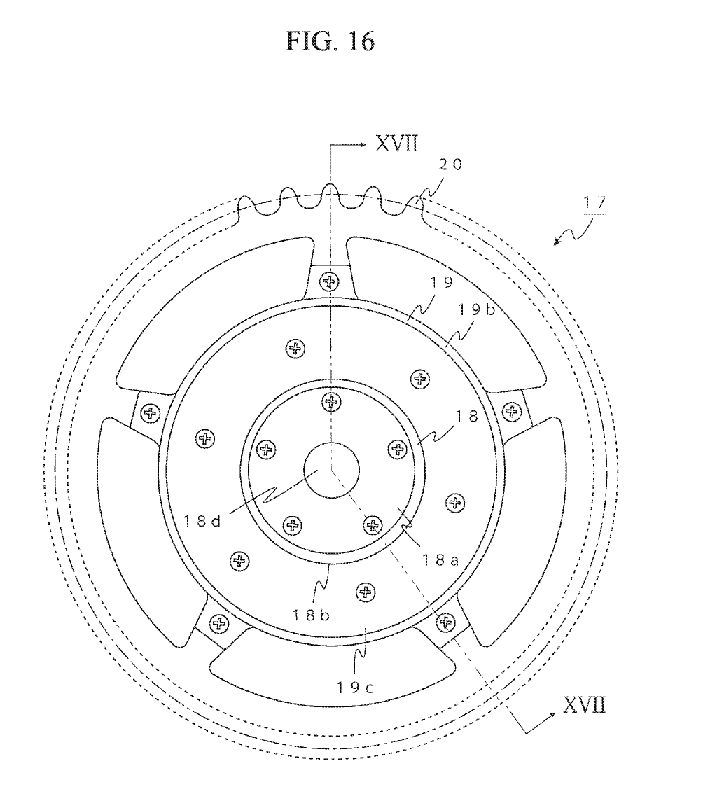

Next, a configuration of the rotation transmission mechanism according to a third embodiment of the invention will be described with reference to FIGS. 16 to 19B.

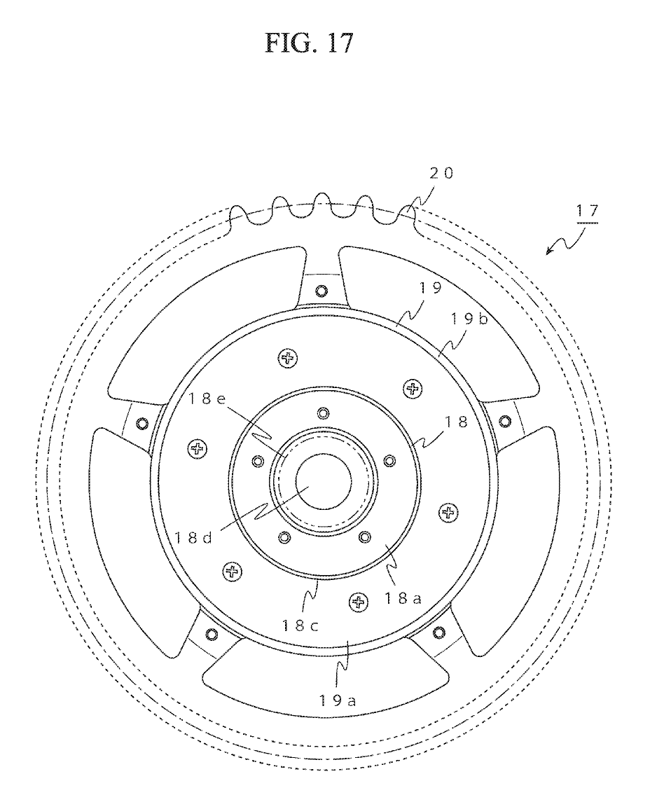

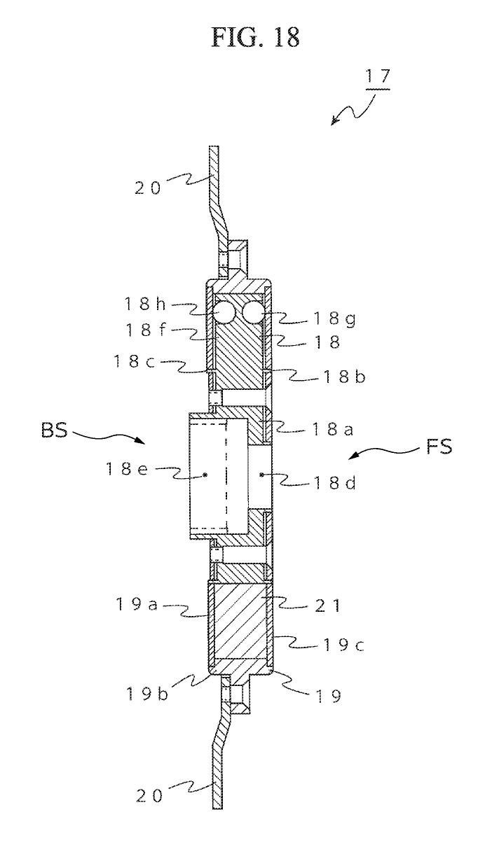

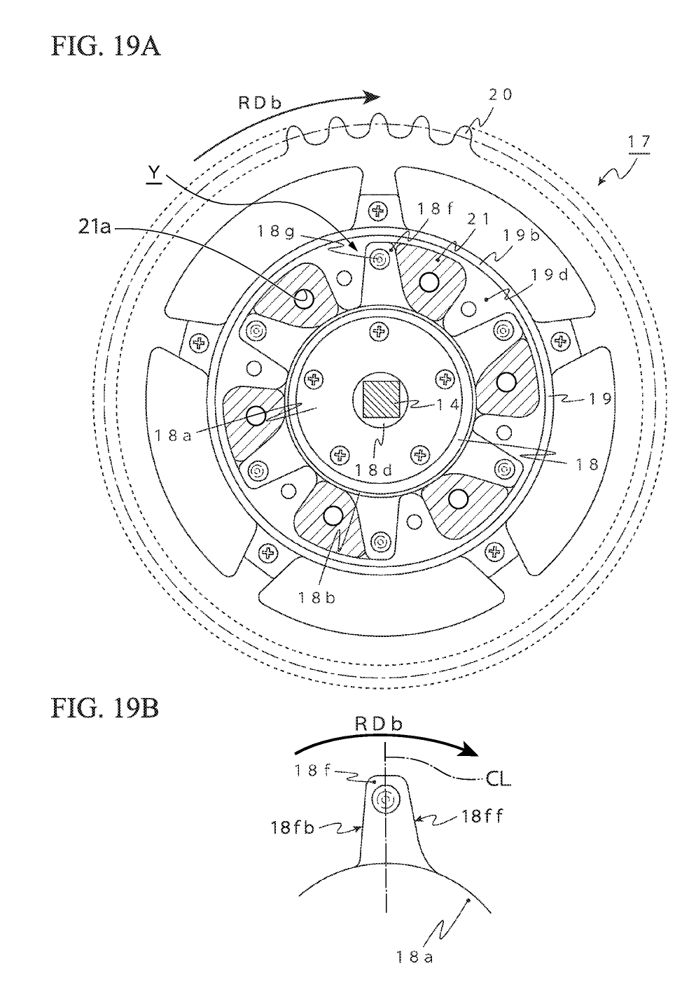

FIG. 16 is a plan view showing a top surface of the rotation transmission mechanism according to the third embodiment of the invention, FIG. 17 is a plan view showing a back surface of the rotation transmission mechanism, FIG. 18 is a cross-sectional view taken along the line XVII-XVII shown in FIG. 16, FIG. 19A is a view showing the rotation transmission mechanism and is a plan view showing a state where the cover portion is removed, and FIG. 19B is an enlarged plan view in which the portion indicated by reference letter Y shown in FIG. 19A is enlarged.

In FIG. 18, reference letter FS represents a top surface of the rotation transmission mechanism, and reference letter BS represents a back surface of the rotation transmission mechanism. That is, a plan view represented by reference letter FS corresponds to FIG. 16, and a plan view represented reference letter BS corresponds to FIG. 17.

As shown in FIGS. 16 to 19B, the rotation transmission mechanism 17 according to the embodiment includes, for example, an internal rotation member 18 into which a rotation shaft such as a crankshaft of an electric assist bicycle is inserted, an external rotation member 19 that is rotatably arranged at the internal rotation member 18, and elastically-deformable portions 21 (elastically-deformable body).

### (Internal Rotation Member)

The internal rotation member 18 includes: a disk-shaped internal rotation member main body 18a; a cylindrical projected portion 18b formed integrally with an outer periphery of a top surface of the internal rotation member main body 18a; a cylindrical projected portion 18c formed integrally with an outer periphery of a back surface of the internal rotation member main body 18a; and a crankshaft insertion hole 18d formed so as to penetrate through the internal rotation member main body 18a. Here, the back surface side the crankshaft insertion hole 18d has a spline hole 18e.

Additionally, the internal rotation member 18 includes six outer-peripheral projected portions 18f that are formed integrally with the internal rotation member main body 18a and protrude from the outer-periphery of the internal rotation member main body 18a to the outside. Bearing balls 18g and 18h are rotatably held by the top surface and the back surface of the outer-peripheral projected portions 18f, respectively. In the radial direction of the internal rotation member 18 (in the centrifugal direction from the crankshaft as a center), the balls 18g and 18h are located at the position at 45 to 65% with respect to the protrusion amount (length) of the outer-peripheral projected portion 18f, preferably, at the position at 58 to 62%. In other words, where the distance from the outer peripheral face of the internal rotation member main body 18a to the outer end of the outer-peripheral projected portion 18f in the radial direction of the internal rotation member 18 is 100%, the balls 18g and 18h are provided at the position at 45 to 65%, preferably, 58 to 62% far from the outer peripheral face of the internal rotation member main body 18a.

As shown in FIG. 19B, each of the outer-peripheral projected portions 18f has a forward-movement surface 18ff and an opposite surface 18fb located on the opposite side of the forward-movement surface 18ff. In other words, the forward-movement surface 18ff is located at the position that is displaced from the center line CL of the outer-peripheral projected portion 18f in the radial direction of the internal rotation member 18 along the rotational direction RDb (forward movement direction, the rotational direction of the rotation transmission mechanism 17 in a case where a bicycle moves forward), that is, the forward-movement surface is located at the right side position of the outer-peripheral projected portion 18f in FIG. 19B. On the other hand, the opposite surface 18fb is located at the position that is displaced from the center line CL of the outer-peripheral projected portion 18f in the radial direction of the internal rotation member 18 along the opposite direction relative to the rotational direction RDb, that is, the opposite surface is located at the left side position of the outer-peripheral projected portion 18f in FIG. 19B.

### (External Rotation Member)

The external rotation member 19 includes a side plate portion 19a, a circular ring 19b, and a cover portion 19c. The side plate portion 19a is located at the side portion of the outer-peripheral projected portion 18f of the internal rotation member 18 and is rotatable relative to the projected portion 18c of the internal rotation member 18. The projected portion 18c is inserted into the insertion hole 19e. The circular ring 19b is screwed to the outer periphery of the side plate portion 19a at the outside of the outer-peripheral projected portions 18f of the internal rotation member 18. The cover portion 19c is rotatable relative to the projected portion 18b in a state of being disposed so as to face the side plate portion 19a. The projected portion 18b is inserted into the cover portion 19c.

Note that, the internal rotation member 18 rotates while the bearing balls 18g and 18h held by the top surface and the back surface of the outer-peripheral projected portion 18f roll on the cover portion 19c and the side plate portion 19a, respectively. By means of this structure, it is possible to smoothly rotate the internal rotation member 18.

Furthermore, the external rotation member 19 includes six inner-peripheral projected portions 19d. The inner-peripheral projected portions 19d are formed integrally with the circular ring 19b so as to protrude toward the inner-peripheral side of the circular ring 19b and are arranged alternately with the outer-peripheral projected portions 18f of the internal rotation member 18. Specifically, a plurality of the inner-peripheral projected portions 19d and a plurality of the outer-peripheral projected portions 18f are arranged so that one outer-peripheral projected portion 18f is disposed between the inner-peripheral projected portions 19d adjacent to each other and one inner-peripheral projected portion 19d is disposed between the outer-peripheral projected portions 18f adjacent to each other in the rotational direction of the rotation transmission mechanism 17.

The side plate portion 19a and the cover portion 19c are screwed to the inner-peripheral projected portion 19d.

Moreover, a chain ring 20 is fixed to the outer-periphery of the back surface side of the circular ring 19b of the external rotation member 19.

### (Elastically-Deformable Portion)

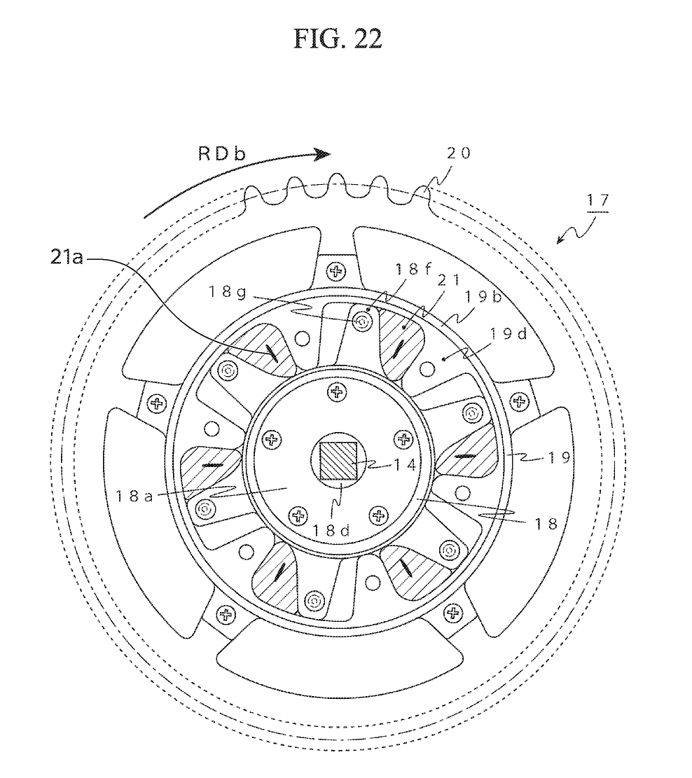

As shown in FIG. 18, the elastically-deformable portion 21 is made of an elastic member such as synthetic rubber and can be elastically deformed. The elastically-deformable portion 21 is sandwiched between the cover portion 19c and the side plate portion 19a and is surrounded by the circular ring 19b. Each of the elastically-deformable portions 21 is held between the forward-movement surface 18ff of the outer-peripheral projected portion 18f and the inner-peripheral projected portion 19d that faces the forward-movement surface 18ff in the rotational direction RDb. Note that, the number of elastically-deformable portions 21 shown in FIGS. 19A and 22 is six; however, the number of elastically-deformable portions 21 is not limited. The elastically-deformable portion 21 transmits torque from the external rotation member 19 to the internal rotation member 18 while being elastically deformed. Furthermore, the elastically-deformable portions 21 transmit, as torque, power-accumulated energy in the elastically-deformable portions 21 to the internal rotation member 18.

Furthermore, as shown in FIG. 19A, a space 21a is partially formed in each of the elastically-deformable portions 21. This space 21a corresponds to the above-mentioned space 6a. As the elastically-deformable portion 21 is compressed by being sandwiched between the outer-peripheral projected portion 18f and the inner-peripheral projected portion 19d, the space 21a is squashed. The elastically-deformable portion 21 including the space 21a can obtain the same action and effect as those of the space 6a.

(Contact Configuration of Elastically-Deformable Portion with Respect to Outer-Peripheral Projected Portion and Inner-Peripheral Projected Portion)

As shown in FIGS. 19A and 19B, the elastically-deformable portion 21 is provided between the forward-movement surface 18ff of the outer-peripheral projected portion 18f and the inner-peripheral projected portion 19d. In other words, the elastically-deformable portion 21 is disposed between the outer-peripheral projected portion 18f and the inner-peripheral projected portion 19d that is located at the position along the rotational direction from the outer-peripheral projected portion 18f when a bicycle moves forward (when the rotation transmission mechanism 17 rotates in the rotational direction RDa). When the internal rotation member 18 and the external rotation member 19 relatively rotate, the elastically-deformable portion 21 is configured so to be sandwiched between the outer-peripheral projected portion 18f and the inner-peripheral projected portion 19d and thereby elastically deformed (compressive deformation). Here, deformation of the elastically-deformable portion 21 in a lateral direction, that is, deformation of the elastically-deformable portion 21 in the axial direction of the rotation transmission mechanism 17 shown in FIG. 18 is prevented by the side plate portion 19a and the cover portion 19c, and therefore part of energy is input to the rotation transmission mechanism 17 due to pedaling by a rider can be effectively power-accumulated in the elastically-deformable portion 21. The space 6a may be provided in the elastically-deformable portion 21.

As shown in FIG. 19B, in the rotation transmission mechanism 17 according to the embodiment, the area of the surface (the forward-movement surface 18ff) directed in the rotational direction of the outer-peripheral projected portion 18f is larger by approximately 10 to 15%, preferably approximately 12 to 13%, than that of the surface (the opposite surface 18fb, the surface located at the position that is displaced from the center line CL along the opposite direction relative to the rotational direction) directed in the direction opposite to the rotational direction. Accordingly, the elastically-deformable portion 21 placed between the outer-peripheral projected portion 18f and the inner-peripheral projected portion 19d that is located at the position along the rotational direction from the outer-peripheral projected portion 18f when a bicycle moves forward (between the forward-movement surface 18ff and the inner-peripheral projected portion 19d) is compressively deformed at a larger area (range) than before, and it is possible to effectively accumulate compression (elastic) energy in the elastically-deformable portion 21. The compression (elastic) energy is converted into rotational energy and is utilized as a propulsive force for an electric assist bicycle or the like.

More particularly, the outer-peripheral projected portion 18f is formed so that the forward-movement surface 18ff (the surface directed in the rotational direction) has a shelving inclination relative to the opposite surface 18fb (the surface directed in the direction opposite to the rotational direction). Furthermore, a curved surface is formed at the boundary portion between the forward-movement surface 18ff (the surface directed in the rotational direction) and the internal rotation member main body 18a. As a result of adopting the foregoing configuration, the height of the outer-peripheral projected portion 18f (the distance from the outer peripheral face of the internal rotation member main body 18a to the outer end of the outer-peripheral projected portion 180 can be lowered by making the surface area of the forward-movement surface 18ff of the outer-peripheral projected portion 18f (the surface directed in the rotational direction) larger, and it is possible to achieve downsizing of the rotation transmission mechanism 17. Moreover, since a length of the outer-peripheral projected portion 18f (the forward-movement surface 18ff) that compresses the elastically-deformable portion 21 increases in a direction from the outer peripheral face of the internal rotation member main body 18a toward the outer end of the outer-peripheral projected portion 18f, larger compression energy can be accumulated therein.

The surface of the inner-peripheral projected portion 19d which faces the forward-movement surface 18ff of the outer-peripheral projected portion 18f (the surface directed in the rotational direction) is formed in a state of being depressed. For this reason, it is possible to increase the amount of the elastically-deformable portion 21 placed between the outer-peripheral projected portion 18f and the inner-peripheral projected portion 19d that is located at the position along the rotational direction from the outer-peripheral projected portion 18f when a bicycle moves forward (between the forward-movement surface 18ff and the inner-peripheral projected portion 19d). Consequently, it is possible to accumulate, the elastically-deformable portion 21, a sufficient amount of compression (elastic) energy to be used as a propulsive force. The volume of the inside space of the recess formed by being depressed is preferably 2 to 5% of the volume of the elastically-deformable portion 21. This is because, if the recess is excessively large, compression of the elastically-deformable portion 21 becomes insufficient.

### (Usage Example of Rotation Transmission Mechanism)

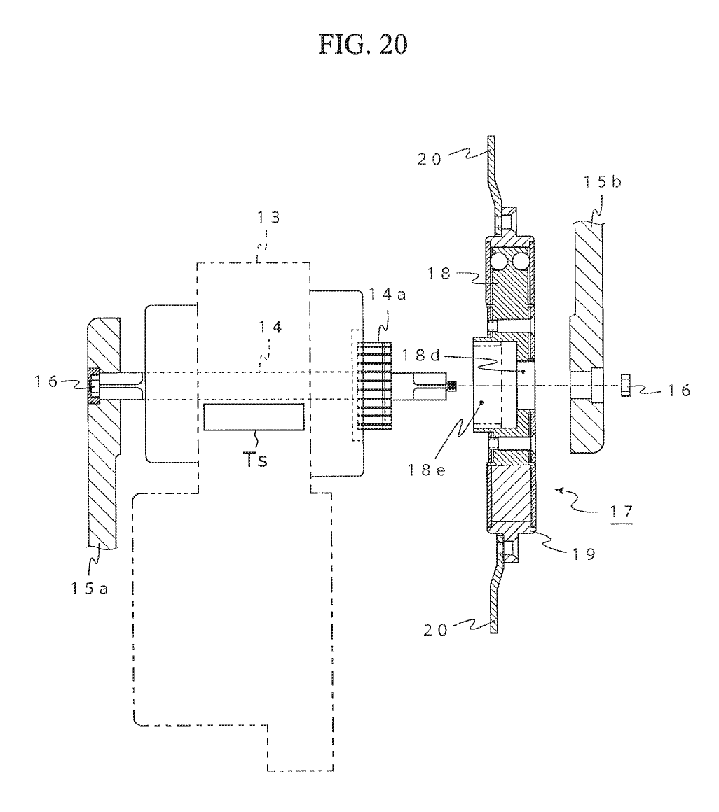

Next, usage example of the rotation transmission mechanism 17 according to the embodiment will be described with reference to FIGS. 20 to 22.

FIG. 20 is a view showing an example in which the rotation transmission mechanism according to the third embodiment of the invention is used in an electric assist bicycle and is an exploded cross-sectional view showing the relevant part of the rotation transmission mechanism.

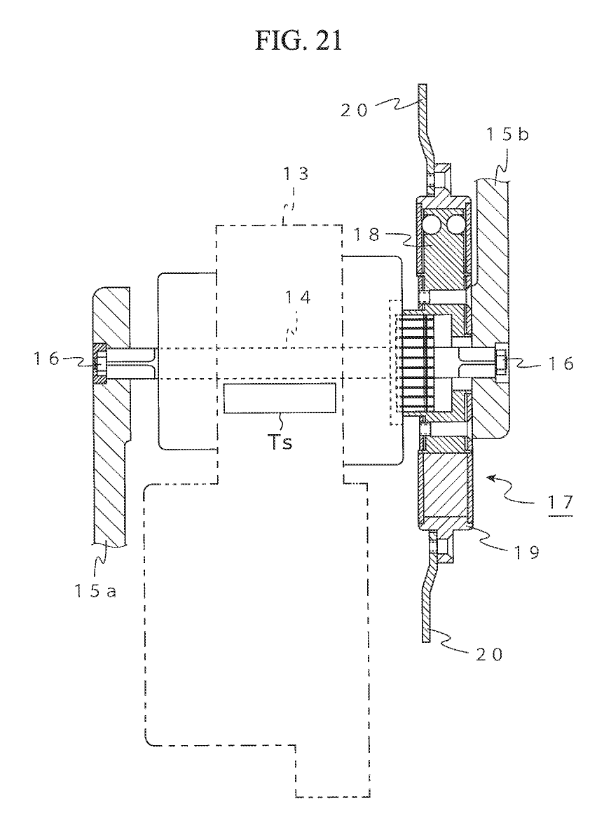

FIG. 21 is a view showing an example in which the rotation transmission mechanism is used in the electric assist bicycle and is a cross-sectional view showing the relevant part of the rotation transmission mechanism.

FIG. 22 is a view showing the rotation transmission mechanism and is a plan view showing a state where an elastically-deformable portion is elastically deformed (compressive deformation) in a state where the cover portion is removed.

The rotation transmission mechanism 17 according to the embodiment is attached to a crankshaft of the electric assist bicycle and used therefor.

As shown in FIGS. 20 and 21, a crankshaft 14 that penetrates through right and left portions of a motor driving unit 13 and serves as a rotation shaft is rotatably held by the motor driving unit 13 of the electric assist bicycle. A spline 14a fitted into the spline hole 18e of the internal rotation member 18 is fixed to the right end of the crankshaft 14 in a concentric form with respect to the crankshaft 14. By inserting the spline 14a into the spline hole 18e of the internal rotation member 18, the rotation transmission mechanism 17 is attached to the right end of the crankshaft 14. In addition, crank arms 15a and 15b are fixed at a phase difference of 180 degrees to both right and left ends of the crankshaft 14. In FIGS. 20 and 21, reference numeral 16 represents a crank arm fixing member that is used to fix the crank arms 15a and 15b to the crankshaft 14.

Rotatable pedals (not shown in the figure) are provided at the ends of the crank arms 15a and 15b.

A torque sensor is disposed at the position close to the crankshaft 14 in the motor driving unit 13, and the torque sensor can detect human driving power due to a leg force which is input to the motor driving unit 13 from the pedal. Therefore, the motor is driven in accordance with the detection result of the torque sensor, and it is possible to assist rotation of the crankshaft 14 (auxiliary driving power).

An action of the rotation transmission mechanism 17 attached to the crankshaft 14 of the electric assist bicycle as described above will be described with reference to FIGS. 19A to 22.

In FIG. 21, when a rider steps the pedals (not shown in the figure) disposed at the ends of the crank arms 15a and 15b, the crankshaft 14 and the outer-peripheral projected portions 18f that is provided to protrude toward the outer periphery of the internal rotation member main body 18a rotate in the direction of the arrow RDb in FIGS. 19A and 22.

Subsequently, when the crankshaft 14 rotates and the outer-peripheral projected portion 18f comes close to the inner-peripheral projected portion 19d, the elastically-deformable portion 21 is compressed by being sandwiched between the outer-peripheral projected portion 18f (the forward-movement surface 18ff) and the inner-peripheral projected portion 19d, and part of input energy is accumulated in the elastically-deformable portion 21.

When the crankshaft 14 initially rotates (from FIG. 19A to FIG. 22), the elastically-deformable portion 21 is elastically deformed; however, after the elastically-deformable portion 21 is deformed, torque of the crankshaft 14 is transmitted from the outer-peripheral projected portion 18f to the inner-peripheral projected portion 19d, and the crankshaft 14 and the chain ring 20 rotate as being a substantially integrated body. Torque is reliably transmitted to a sprocket provided at the rear wheel side of a bicycle via a chain (not shown in the figure) provided on the chain ring 20 in a tensioned state.

The elastically-deformable portion 21 elastically deformed (compressive deformation) restores when energy input from the pedals to the rotation transmission mechanism 17 is stopped or weakened, presses the inner-peripheral projected portion 19d as restoring energy, and causes the external rotation member 19 and the chain ring 20 to rotate in a traveling direction. That is, compression (elastic) energy of the elastically-deformable portion 21 is converted into rotational energy and utilized as a propulsive force for an electric assist bicycle.

Furthermore, the human driving power due to a leg force which is input to the motor driving unit 13 from the pedal is detected by the torque sensor, and auxiliary driving power (assist force) of the motor corresponding to the human driving power is applied. Consequently, it is possible to easily ride even steep slopes.

As described above, as the rotation transmission mechanism according to the invention is attached to and used for the crankshaft of the electric assist bicycle as described above, it is possible to significantly relieve the rider's fatigue.

Note that, in the embodiment, the case where six outer-peripheral projected portions 18f and six inner-peripheral projected portions 19d are provided is described as an example; however, the invention is not limited to the above-described configuration. It is only necessary that the number of outer-peripheral projected portions 18f and the number of inner-peripheral projected portions 19d are each one or more. In order to transmit the force accumulated in the elastically-deformable portions 21 to them in the circumferential direction, it is preferable that the number of outer-peripheral projected portions 18f and the number of inner-peripheral projected portions 19d be greater than or equal to four. Furthermore, in order to sufficiently ensure the volume of the elastically-deformable portion 21, it is preferable that each of the numbers of the outer-peripheral projected portions 18f and the inner-peripheral projected portions 19d be less than or equal to eight.

Moreover, in the embodiment, the case where the outer-peripheral projected portions 18f are formed integrally with the internal rotation member main body 18a is described as an example; however, the invention is not limited to the above-described configuration. The outer-peripheral projected portions may be fixed to the internal rotation member main body.

Furthermore, in the embodiment, the case where the inner-peripheral projected portions 19d are formed integrally with the circular ring 19b is described as an example; however, the invention is not limited to the above-described configuration. The inner-peripheral projected portion may be fixed to the circular ring.

Moreover, in the embodiment, the case where the elastically-deformable portion is the elastically-deformable portions 21 made of synthetic rubber is described as an example; however, the invention is not limited to the above-described configuration.

It is only necessary that the elastically-deformable portion is elastically deformed (compressive deformation) when the internal rotation member 18 and the external rotation member 19 relatively rotate and that after the deformation, the elastically-deformable portion can transmit rotation between the internal rotation member 18 and the external rotation member 19. Deformation amount, coefficient of elasticity, or the like of the elastically-deformable portion can be appropriately selected depending on a user's preference. As the elastically-deformable portion, not only synthetic rubber but also a gas or the like sealed between, for example, the outer-peripheral projected portion 18f and the inner-peripheral projected portion 19d can be used.

Furthermore, in the embodiment, the rotation transmission mechanism 17 used in an electric assist bicycle is described as an example; however, the rotation transmission mechanism according to the invention is not limited to the above-described intended use. The rotation transmission mechanism according to the embodiment of the invention is also applicable to a mechanism having a wheel such as a general bicycle, a unicycle used for civil engineering, a wheelchair, a rickshaw, a rear car, or the like, and it is possible to obtain the same action and effect as those of the above.

### Fourth Embodiment

### (Configuration of Rotation Transmission Mechanism)

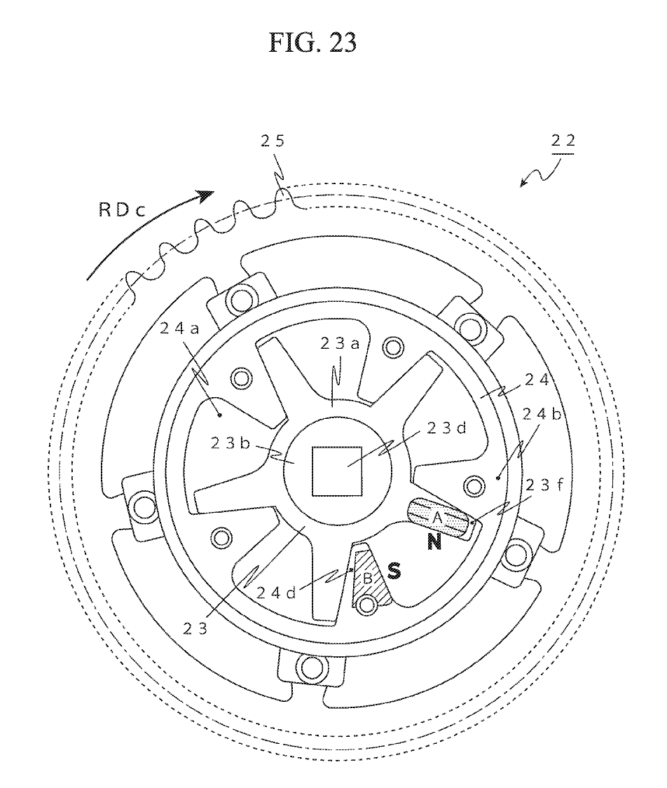

Next, a configuration of a rotation transmission mechanism according to a fourth embodiment of the invention will be described with reference to FIG. 23.

FIG. 23 is a view showing the rotation transmission mechanism according to a fourth embodiment of the invention and is a plan view showing a state where the cover portion is removed.

As shown in FIG. 23, a rotation transmission mechanism 22 according to the embodiment includes, for example, an internal rotation member 23 into which a crankshaft or the like of a bicycle such as a rotation shaft is inserted, and an external rotation member 24 rotatably arranged at the internal rotation member 23. The rotation transmission mechanism 22 according to the embodiment can be used for not only a bicycle but also a mechanism having a wheel and a robot (joint portion or the like). The internal rotation member 23 includes: a disk-shaped internal rotation member main body 23a; a columnar projected portion 23b formed integrally with an outer periphery of a top surface of the internal rotation member main body 23a; a columnar projected portion 23c (projected portions 23c are not shown in the figure) formed integrally with an outer periphery of a back surface of the internal rotation member main body 23a; and a crankshaft insertion hole 23d formed so as to penetrate through the internal rotation member main body 23a.

Additionally, the internal rotation member 23 includes five outer-peripheral projected portions 23f that are formed integrally with the internal rotation member main body 23a and protrude from the outer-periphery of the internal rotation member main body 23a to the outside. Bearing balls (not shown in the figure) are rotatably held by the top surface and the back surface of the outer-peripheral projected portions 23f, respectively.

Similar to the aforementioned outer-peripheral projected portion, The outer-peripheral projected portion 23f has a forward-movement surface and an opposite surface.

Particularly, the outer-peripheral projected portion 23f is formed so that the forward-movement surface (the surface directed in the rotational direction) has a shelving inclination relative to the opposite surface (the surface directed in the direction opposite to the rotational direction). Furthermore, a curved surface is formed at the boundary portion between the forward-movement surface (the surface directed in the rotational direction) and the internal rotation member main body 23a.

The external rotation member 24 includes a side plate portion 24a, a circular ring 24b, and a cover portion (not shown in the figure). The side plate portion 24a is located at the side portion of the outer-peripheral projected portion 23f of the internal rotation member 23 and is rotatable relative to the projected portion 23c of the internal rotation member 23. The projected portion 23c is inserted into the side plate portion 24a. The circular ring 24b is screwed to the outer periphery of the side plate portion 24a at the outside of the outer-peripheral projected portions 23f of the internal rotation member 23. The cover portion is rotatable relative to the projected portion 23b in a state of being disposed so as to face the side plate portion 24a. The projected portion 23b is inserted into the cover portion.

Note that, the internal rotation member 23 rotates while the bearing balls held by the top surface and the back surface of the outer-peripheral projected portion 23f roll on the cover portion and the side plate portion 24a, respectively. By means of this structure, it is possible to smoothly rotate the internal rotation member 23.

Furthermore, the external rotation member 24 includes five inner-peripheral projected portions 24d. The inner-peripheral projected portions 24d are formed integrally with the circular ring 24b so as to protrude toward the inner-peripheral side of the circular ring 24b and are arranged alternately with the outer-peripheral projected portions 23f of the internal rotation member 23. Specifically, a plurality of the inner-peripheral projected portions 24d and a plurality of the outer-peripheral projected portions 23f are arranged so that one outer-peripheral projected portion 23f is disposed between the inner-peripheral projected portions 24d adjacent to each other and one inner-peripheral projected portion 24d is disposed between the outer-peripheral projected portions 23f adjacent to each other in the rotational direction of the rotation transmission mechanism 22.

The side plate portion 24a and the cover portion are screwed to the inner-peripheral projected portion 24d.

Moreover, a chain ring 25 is fixed to the outer-periphery of the back surface side of the circular ring 24b of the external rotation member 24.

An electromagnet A is attached to the outer-peripheral projected portion 23f, and a permanent magnet B is attached to the inner-peripheral projected portion 24d that is located at the position along the rotational direction from the outer-peripheral projected portion 23f when a bicycle moves forward.

The permanent magnet B is attached to the inner-peripheral projected portion 24d so that a magnetic pole of the portion thereof facing the electromagnet A is south polarity.

The electromagnet A is configured so that a magnetic pole of the portion thereof facing the permanent magnet B can be switched to north polarity or south polarity. The switching of magnetic pole can be realized by, for example, changing the direction of the electrical current flowing to the electromagnet A. Additionally, the switching of magnetic pole is carried out at, for example, the timing when rotation of the crankshaft is stopped, and a determination whether or not rotation of the crankshaft is stopped can be carried out by, for example, use of a torque sensor built in a motor driving unit of an electric assist bicycle.

### (Action of Rotation Transmission Mechanism)

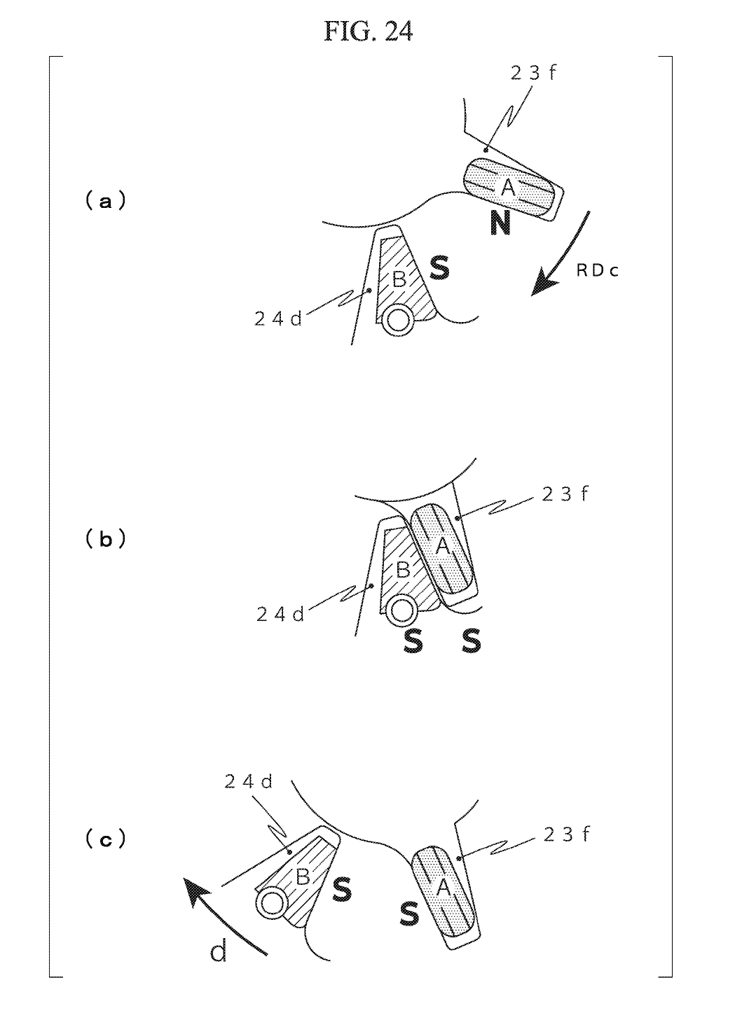

Next, the rotation transmission mechanism 22 according to the embodiment will be described with reference to FIG. 24. Here, the case where the rotation transmission mechanism 22 is attached to a crankshaft of a bicycle is described as an example.

FIG. 24 is an explanatory diagram for explaining an action of the rotation transmission mechanism according to the fourth embodiment of the invention.

As shown in FIG. 23, firstly, the portion of the electromagnet A attached to the outer-peripheral projected portion 23f which faces the permanent magnet B attached to the inner-peripheral projected portion 24d is north polarity. In this state, when a rider steps the pedals provided at ends of the crank arms, the crankshaft and the outer-peripheral projected portions 23f that is provided to protrude toward the outer periphery of the internal rotation member main body 23a rotate in the direction of the arrow RDc (forward movement direction) in FIGS. 23A and 24(a), the outer-peripheral projected portion 23f to which the electromagnet A is attached comes into contact with the inner-peripheral projected portion 24d to which the permanent magnet B is attached (north polarity of the electromagnet A is attracted to south polarity of the permanent magnet B). After the outer-peripheral projected portion 23f comes into contact with the inner-peripheral projected portion 24d, torque of the crankshaft is transmitted from the outer-peripheral projected portions 23f to the inner-peripheral projected portions 24d, and the crankshaft and the chain ring 25 rotate as being a substantially integrated body. Torque is reliably transmitted to a sprocket provided at the rear wheel side of a bicycle via a chain (not shown in the figure) provided on the chain ring 25 in a tensioned state.

When a rider stops stepping the pedals provided at ends of the crank arms, the rotation of the crankshaft is stopped, and the torque sensor detects stop of rotation. Subsequently, a signal is transmitted from the torque sensor to a current controller, the direction of the electrical current flowing in the electromagnet A is changed by the current controller, a magnetic pole of the portion of the electromagnet A which faces the permanent magnet B is switched from north polarity to south polarity (refer to FIG. 24 (b)). As a result, as shown in FIGS. 24 (b) and (c), the inner-peripheral projected portion 24d to which the permanent magnet B is attached is separated from the outer-peripheral projected portion 23f to which the electromagnet A is attached (south polarity of the electromagnet A and south polarity of the permanent magnet B repel each other) (refer to the arrow d in FIG. 24 (c)). Because of this, the external rotation member 24 rotates, in a state where the inner-peripheral projected portion 24d is in contact with the outer-peripheral projected portion 23f, the external rotation member 24 further rotates together with the internal rotation member 23 (crankshaft) and thereafter stopped.

When the rotation of the crankshaft is stopped, the torque sensor detects the stop of rotation. Subsequently, a signal is transmitted from the torque sensor to a current controller, the direction of the electrical current flowing in the electromagnet A is changed by the current controller, a magnetic pole of the portion of the electromagnet A which faces the permanent magnet B is switched from south polarity to north polarity (refer to FIG. 24 (a)). As a result, the outer-peripheral projected portion 23f to which the electromagnet A is attached comes close to the inner-peripheral projected portion 24d to which the permanent magnet B is attached, the outer-peripheral projected portion 23f to which the electromagnet A is attached comes into contact with the inner-peripheral projected portion 24d to which the permanent magnet B is attached (north polarity of the electromagnet A is attracted to south polarity of the permanent magnet B). At this time, once the crankshaft rotates together with the internal rotation member 23, and thereafter is stopped.

When the rotation of the crankshaft is stopped, the torque sensor detects the stop of rotation. Subsequently, a signal is transmitted from the torque sensor to a current controller, the direction of the electrical current flowing in the electromagnet A is changed by the current controller, a magnetic pole of the portion of the electromagnet A which faces the permanent magnet B is switched from north polarity to south polarity (refer to FIG. 24 (b)). As a result, as shown in FIG. 24 (c), the inner-peripheral projected portion 24d to which the permanent magnet B is attached is separated from the outer-peripheral projected portion 23f to which the electromagnet A is attached (south polarity of the electromagnet A and south polarity of the permanent magnet B repel each other) (refer to the arrow d in FIG. 24 (c)). Because of this, the external rotation member 24 rotates, in a state where the inner-peripheral projected portion 24d is in contact with the outer-peripheral projected portion 23f, the external rotation member 24 further rotates together with the internal rotation member 23 (crankshaft) and thereafter stopped.

The actions described above are repeated, the crankshaft 24 and the chain ring 25 rotate as being a substantially integrated body. Torque is transmitted to a sprocket provided at the rear wheel side of a bicycle via a chain (not shown in the figure) provided on the chain ring 25 in a tensioned state.

Note that, in the embodiment, the case where the electromagnet A is attached to the outer-peripheral projected portion 23f and where the permanent magnet B is attached to the inner-peripheral projected portion 24d that is located at the position along the rotational direction from the outer-peripheral projected portion 23f when a bicycle moves forward is described as an example; however, the invention is not limited to the above-described configuration. A permanent magnet may be attached to the outer-peripheral projected portion 23f and an electromagnet may be attached to the inner-peripheral projected portion 24d that is located at the position along the rotational direction from the outer-peripheral projected portion 23f when a bicycle moves forward. Moreover, an electromagnet may be attached to both the outer-peripheral projected portion 23f and the inner-peripheral projected portion 24d that is located at the position along the rotational direction from the outer-peripheral projected portion 23f when a bicycle moves forward.

Additionally, in the embodiment, the case where five outer-peripheral projected portions 23f and five inner-peripheral projected portions 24d are provided is described as an example; however, the invention is not limited to the above-described configuration. It is only necessary that the number of outer-peripheral projected portions 23f and the number of inner-peripheral projected portions 24d are each one or more.

Furthermore, in the embodiment, the case where the outer-peripheral projected portions 23f are formed integrally with the internal rotation member main body 23a is described as an example; however, the invention is not limited to the above-described configuration. The outer-peripheral projected portion may be fixed to the internal rotation member main body.

In addition, in the embodiment, the case where the inner-peripheral projected portions 24d are formed integrally with the circular ring 24b is described as an example; however, the invention is not limited to the above-described configuration. The inner-peripheral projected portion may be fixed to the circular ring.

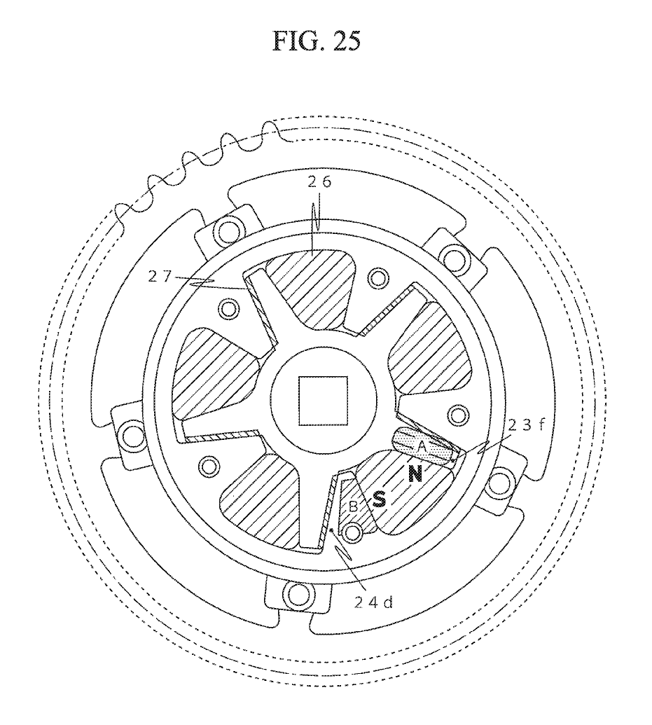

Furthermore, even in the embodiment, similar to the above-mentioned first to fourth embodiments, as shown in FIG. 25, an elastically-deformable portion 26 (elastically-deformable body) may be disposed between the outer-peripheral projected portion 23f and the inner-peripheral projected portion 24d that is located at the position along the rotational direction from the outer-peripheral projected portion 23f when a bicycle moves forward (between the forward-movement surface of the outer-peripheral projected portion 23f and the inner-peripheral projected portion 24d).

Moreover, by attaching an elastic member 27 made of elastomer or the like to the surface directed in the direction opposite to the rotational direction of the outer-peripheral projected portion 23f, it may provide a damping effect. The aforementioned the space 6a may be provided in the elastic member 27.

### Fifth Embodiment

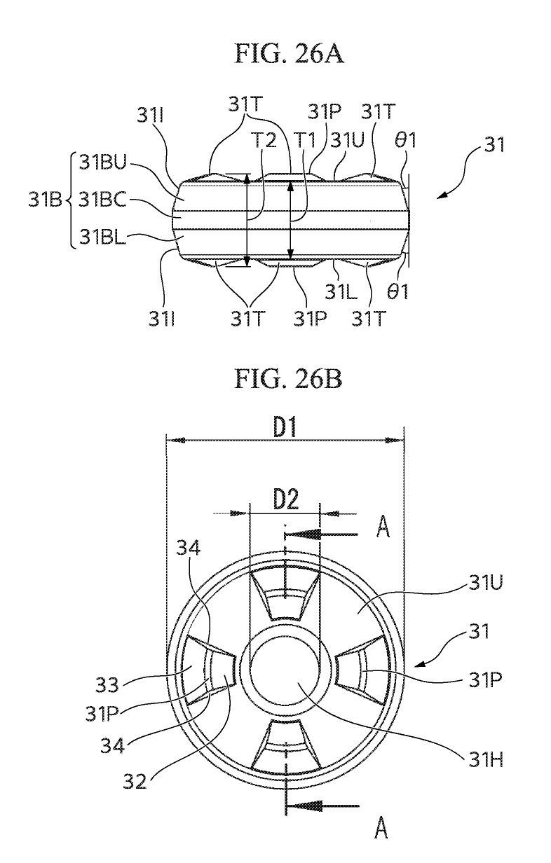

Next, a configuration of an elastically-deformable portion (elastically-deformable body) according to a fifth embodiment of the invention will be described with reference to FIGS. 26A and 26B.

The elastically-deformable portion described below is a modified example of the above-mentioned elastically-deformable portions 6, 6A, 21, and 26.

As shown in FIG. 26A, an elastically-deformable portion 31 has: a circular main body 31B having an upper surface 31U and a lower surface 31L; and protruding portions 31T provided on each of the upper surface 31U and the lower surface 31L. Since four protruding portions 31T are provided on each of the upper surface 31U and the lower surface 31L, the elastically-deformable portion 31 has eight protruding portions 31T in total.

On each of the upper surface 31U and the lower surface 31L, the four protruding portions 31T are arranged at even intervals, that is, the pitch angle at which the four protruding portions 31T are arranged is 90 degrees.

Note that, in the embodiment, an example where the protruding portions 31T are formed on both the upper surface 31U and the lower surface 31L is described; however, it is only necessary that protruding portions 31T are provided on at least one of the upper surface 31U and the lower surface 31L. For example, a structure in which the protruding portions 31T are provided only on the upper surface 31U or a structure in which the protruding portions 31T are provided only on the lower surface 31L may be adopted.

A through hole 31H (space) that penetrates through the main body 31B is provided at the center of the main body 31B, that is, the main body 31B is formed in a ring shape. In the case where the elastically-deformable portion 31 is incorporated into a rotation transmission mechanism, the elastically-deformable portion 31 is held between the cover portion 4c (19c) and the side plate portion 4a (19a) and is surrounded by the circular ring 4b (19b). Furthermore, the elastically-deformable portion 31 is sandwiched between the forward-movement surface 3ff (18ff) of the outer-peripheral projected portion 3f (18f) and the inner-peripheral projected portion 4d (19d).

Note that, in the embodiment, a through hole formed in an elastically-deformable portion is described as an example of a space; however, a structure in which a recess is formed at the center of the elastically-deformable portion may be adopted instead of the through hole. In this case, a recess may be formed on one surface of the upper surface 31U and the lower surface 31L, and a recess may be formed on both the upper surface 31U and the lower surface 31L.

As shown in FIG. 26A, as seen from the side surface of the elastically-deformable portion 31, each of the protruding portions 31T has an isosceles triangular shape. Note that, a top portion 31P of the protruding portion 31T, that is, a portion located at the apex angle of the isosceles triangle is chamfered. The top portion 31P may be not only a flat surface but also a curved surface.

As shown in FIG. 26B, when seen in a plan view, each of the protruding portions 31T has a shape which radially expands in a radial-outer direction from the through hole 31H as the center, that is, a substantially fan shape such that the portion thereof close to the center is cutout.

More particularly, each of the protruding portions 31T has an inner-inclined surface 32 and an outer-inclined surface 33 which correspond to two equilateral sides of the isosceles triangle. The inner-inclined surface 32 is a surface extending so as to rise from the through hole 31H toward the top portion 31P. The outer-inclined surface 33 is a surface extending so as to lower from the top portion 31P toward the outside of the elastically-deformable portion 31.

Furthermore, each of the protruding portions 31T includes two inclined-side surfaces 34 which serve as surfaces different from the inner-inclined surface 32 and the outer-inclined surface 33. On the protruding portion 31T formed on the upper surface 31U, the inclined-side surface 34 is a surface extending from the upper surface 31U toward the top portion 31P. On the protruding portion 31T formed on the lower surface 31L, the inclined-side surface 34 is a surface extending from the lower surface 31L toward the top portion 31P.

The main body 31B has a center region 31BC located at the center in the thickness direction of the elastically-deformable portion 31, a upper region 31BU having the upper surface 31U, and a lower region 31BL having the lower surface 31L. On the side surface of the elastically-deformable portion 31, each of the upper region 31BU and the lower region 31BL has an inclined surface 31I inclined with respect to the side surface of the center region 31BC. Particularly, the center region 31BC, the upper region 31BU, and the lower region 31BL, which constitute the main body 31B are not separate bodies but are integrally formed into one body.

Regarding the size of the elastically-deformable portion 31, an outer diameter D1 of the elastically-deformable portion 31, that is, an outer diameter D1 of the center region 31BC is approximately 21 mm. In addition, a diameter of the through hole 31H is approximately 7 mm. A thickness between the upper surface 31U and the lower surface 31L is approximately 7 mm. A length between the top portion 31P of the protruding portion 31T formed on the upper surface 31U and the top portion 31P of the protruding portion 31T formed on the lower surface 31L is approximately 8 mm. The inclination angle θ1 of the inclined surface 31I with respect to the side surface of the center region 31BC is approximately 23 degrees.

As a material of the elastically-deformable portion 31, not only an elastic member such as synthetic rubber but also elastomer can be used as well as the others and a known elastic material.

The elastically-deformable portion 31 is applicable to the rotation transmission mechanism instead of the aforementioned elastically-deformable portions 6, 6A, 21, and 26. Note that, in the case where the elastically-deformable portion 31 according to the embodiment is applied to the rotation transmission mechanisms 1 and 17, it is necessary to match the number of elastically-deformable portions 31 according to the embodiment to the number of outer-peripheral projected portions 3f and 18f and the number of inner-peripheral projected portions 4d and 19d.

### (Attachment Structure)

The elastically-deformable portion 31 is held between the side plate portion (4a, 19a) serving as an internal rotator and the cover portion (4c, 19c) serving as an external rotator and is sandwiched between the outer-peripheral projected portion (3f, 18f) of the internal rotation member (3, 18) and the inner-peripheral projected portion (4d, 19d). Specifically, as described above embodiment, it is sandwiched between the forward-movement surface of the outer-peripheral projected portion and the inner-peripheral projected portion.

When a bicycle moves forward, that is, the rotation transmission mechanism rotates in the rotational direction (the aforementioned reference letters RDa and RDb), the internal rotator and the external rotator relatively rotate, the elastically-deformable portion 31 is elastically deformed (compressive deformation). Subsequently, the elastically-deformable portion 31 rotates while being compressed, and in accordance with this, the entire chain ring rotates. Part of energy is input to the rotation transmission mechanism due to pedaling by a rider can be effectively power-accumulated in the elastically-deformable portion 31.

Additionally, in the case where the elastically-deformable portion 31 is compressed, in the phase of changing the shape of the elastically-deformable portion 31 so that the through hole 31H formed in the elastically-deformable portion 31 is squashed and in the phase of entirely compressing the elastically-deformable portion 31 while maintaining the shape of the pressed elastically-deformable portion 31, that is, in two phases of compression states, the elastically-deformable portion 31 is compressed. Accordingly, two types of compression ratio (compression state, compression shape) can be obtained by one elastic body.

That is, the elastically-deformable portion 31 is compressed in the embodiment, firstly, a compressed shape is obtained such that the through hole 31H is squashed, thereafter, in a state where the space of the through hole 31H of the elastically-deformable portion 31 is absent, a compressed shape is obtained such that the entirety of the elastically-deformable portion 31 is squashed. In other words, before the through hole 31H is squashed, compression is carried out in a state where a degree of hardness of the elastically-deformable portion 31 in the entire shape thereof is low (soft). After the through hole 31H is squashed, compression is carried out in a state where a degree of hardness of the elastically-deformable portion 31 in the entire shape thereof is high (hard).

Moreover, as shown in FIGS. 26A and 26B, the upper surface 31U and the lower surface 31L are not a flat surface, and the protruding portions 31T are formed on the upper surface 31U and the lower surface 31L. Consequently, when the elastically-deformable portion 31 is held between the cover portion and the side plate portion, the upper surface 31U and the lower surface 31L do not come into contact with the cover portion and the side plate portion, and the top portions 31P of the protruding portions 31T come into contact with the cover portion and the side plate portion. Accordingly, as compared with the structure in which the protruding portion 31T is not formed (refer to FIGS. 3, 6A, and 10A), the area at which the elastically-deformable portion 31 is in contact with the cover portion and the side plate portion is small, and therefore friction between the elastically-deformable portion 31 and the cover portion and between the elastically-deformable portion and the side plate portion is small. As a result, change in shape of the elastically-deformable portion 31, that is, compression of the elastically-deformable portion 31 is further smoothly carried out, and the loss of a force (energy which is input to a rotation transmission mechanism) due to the aforementioned friction is reduced.

The protruding portion 31T of the elastically-deformable portion 31 has an isosceles triangular shape in cross-sectional view and has the inner-inclined surface 32, the outer-inclined surface 33, and the inclined-side surface 34. As the protruding portion 31T has the above-described shape, the elastically-deformable portion 31 is prevented from being distorted in a radiation direction (radial-outer direction, the direction from the through hole 31H toward the outer periphery of the elastically-deformable portion 31) of the elastically-deformable portion 31, and the flat plate shape of the elastically-deformable portion 31 can be maintained while sufficiently power-accumulating energy is input to the rotation transmission mechanism.

Note that, in the aforementioned embodiment, isosceles triangle is adopted as the cross-sectional shape of the protruding portion 31T; however, other shapes may be adopted. For example, a circular shape or an elliptical shape may be adopted instead of the isosceles triangle. However, in the case of adopting a circular shape or an elliptical shape, the cost of manufacturing a die of the elastically-deformable portion having protruding portions increases. As the isosceles triangle is adopted as the cross-sectional shape of the protruding portion 31T, it is possible to reduce the cost of manufacturing a die of the elastically-deformable portion.

Furthermore, since the configuration in which the entire elastically-deformable portion 31 is compressed and the entire chain ring rotates is adopted, when the elastically-deformable portion 31 is compressed, a stress is concentrated in a portion having a low strength, and the shape of the elastically-deformable portion 31 may be locally changed. In contrast, each of the protruding portions 31T has a shape which radially expands, that is, a substantially fan shape. Accordingly, it is possible to increase the width of the protruding portion 31T (the length of the outside portion of the protruding portion 31T in a circumferential direction) at the outer-peripheral portion which easily and largely changes in shape, and it is possible to reduce the width of the protruding portion 31T at the inside portion (the position close to the crankshaft) which is less likely to change in shape. As a result, it is possible to entirely deform the elastically-deformable portion 31 in a well-balanced manner, and it is possible to sufficiently power-accumulate energy by elastic deformation.

The preferred embodiments of the present invention have been described above. However, it should be noted that these embodiments are merely examples of the present invention and do not limit the present invention. Additions, omissions, substitutions, and other modifications can be made within a range not departing from the scope of the present invention. Accordingly, the present invention is not limited to the above description and is only limited by the attached Claims.

What is claimed is:

1. A rotation transmission mechanism comprising:
an internal rotation member into which a rotation shaft is inserted; and
an external rotation member rotatably arranged with respect to the internal rotation member,
wherein the internal rotation member comprises: a disk-shaped internal rotation member main body having a rotation shaft insertion hole; and one or a plurality of outer-peripheral projected portions which are formed integrally with the internal rotation member main body or fixed to the internal rotation member main body and protrude toward an outer-peripheral side of the internal rotation member main body,
wherein the external rotation member comprises: a circular ring rotatably arranged with respect to the internal rotation member and at an outside of the outer-peripheral projected portions of the internal rotation member; and one or a plurality of inner-peripheral projected portions which are formed integrally with the circular ring or fixed to the circular ring so as to protrude toward an inner-peripheral side of the circular ring and are alternately arranged with respect to the outer-peripheral projected portions of the internal rotation member,
wherein the outer-peripheral projected portions have a forward-movement surface that is located at a position displaced from a center of the outer-peripheral projected portion in a forward movement direction in which the rotation transmission mechanism rotates by forward movement,
wherein an elastically-deformable portion is disposed between the forward-movement surface and the inner-peripheral projected portion facing the forward-movement surface in the forward movement direction,
wherein a space is partially formed in the elastically-deformable portion, and
wherein when the internal rotation member rotates relative to the external rotation member, the elastically-deformable portion is sandwiched between the outer-peripheral projected portion and the inner-peripheral projected portion and is thereby elastically deformed.

2. The rotation transmission mechanism according to claim 1,
wherein the external rotation member comprises a side plate portion and a cover portion, and
wherein the elastically-deformable portion is sandwiched between the side plate portion and the cover portion and the space is in a substantially tightly sealed state.

3. The rotation transmission mechanism according to claim 1,
wherein the outer-peripheral projected portion is formed so as to have a shelving inclination relative to an opposite surface on the opposite side of the forward-movement surface, and
wherein a curved surface is formed at a boundary portion between the forward-movement surface and the internal rotation member main body.

4. The rotation transmission mechanism according to claim 1,
wherein the elastically-deformable portion comprises a main body having a space and a protruding portion provided on a surface of the main body, and
wherein the protruding portion has a shape in plan view which radially expands from the space to the elastically-deformable portion in a radial-outer direction.

5. The rotation transmission mechanism according to claim 4,
wherein the protruding portion of the elastically-deformable portion has an isosceles triangular shape in cross-sectional view.

6. The rotation transmission mechanism according to claim 4,
wherein the main body of the elastically-deformable portion has an upper surface and a lower surface, and
wherein the protruding portion is provided on at least one of the upper surface and the lower surface.

7. A bicycle comprising a rotation transmission mechanism according to claim 1.

8. An elastically-deformable body used in the rotation transmission mechanism according to claim 1, comprising:
a main body having a space; and
a protruding portion provided on a surface of the main body,
wherein the protruding portion has a shape in plan view which radially expands from the space to the elastically-deformable portion in a radial-outer direction.
